(19) United States
(12) Patent Application Publication
(10) Pub. No.: US 2013/0140506 A1
(43) Pub. Date: Jun. 6, 2013

(54) HOST-GUEST MATERIALS HAVING TEMPERATURE-DEPENDENT DUAL EMISSION

(71) Applicants: Daniel R. Gamelin, Seattle, WA (US); Rémi Beaulac, Seattle, WA (US); Nils Janssen, Seattle, WA (US); Vladimir Vlaskin, Seattle, WA (US); Emily Jane McLaurin, Seattle, WA (US); Majed Samir Fataftab, Seattle, WA (US)

(72) Inventors: Daniel R. Gamelin, Seattle, WA (US); Rémi Beaulac, Seattle, WA (US); Nils Janssen, Seattle, WA (US); Vladimir Vlaskin, Seattle, WA (US); Emily Jane McLaurin, Seattle, WA (US); Majed Samir Fataftab, Seattle, WA (US)

(73) Assignee: University of Washington through its Center for Commercialization, Seattle, WA (US)

(21) Appl. No.: 13/471,362

(22) Filed: May 14, 2012

Related U.S. Application Data
(60) Provisional application No. 61/485,260, filed on May 12, 2011.

(51) Int. Cl. C09K 11/88

(52) U.S. Cl. CPC C09K 11/883
USPC 252/519.4; 252/500

(57) ABSTRACT

A composition is provided comprising a host material and a luminescent dopant. The composition exhibits dual luminescent emission peaks, one each for the host material and the luminescent dopant. The intensity of the emission peaks vary in intensity as a result of the changing temperature of the composition. This quality enables the composition to be used for ratiometric optical thermometry, including exemplary applications, such as in situ temperature sensing.

### CROSS-REFERENCE TO RELATED APPLICATION

This application claims the benefit of U.S. Provisional Application No. 61/485,260, filed May 12, 2011, the disclosure of which is expressly incorporated herein by reference in its entirety.

### STATEMENT OF GOVERNMENT LICENSE RIGHTS

This invention was made with government support under DMR-0906814, awarded by the National Science Foundation. The government has certain rights in the invention.

### BACKGROUND

Temperature plays critical roles in many biological and biotechnological processes ranging from calcium signaling and protein folding to PCR and thermotherapy. The importance of temperature in such processes has fueled interest in the development of in situ temperature sensors. Measurement of the temperature-dependent photoluminescence (PL) intensities of molecular probes is a popular approach to thermometry in biotechnology. This type of optical measurement is attractive because of its simplicity and excellent spatial and temporal resolution. Numerous luminescent probes based on fluorescent dyes and semiconductor nanocrystals have been developed for this purpose. However, the present materials for optical temperature measurement are not sufficient for all applications. Accordingly, development of improved materials is ongoing.

Relatedly, colloidal semiconductor nanocrystals (also called quantum dots, “QDs”) are powerful optical materials that combine the photo-stability of conventional crystalline inorganic phosphors with the processing flexibility of molecular dyes or luminophores and the rich electronic structures of semiconductors. As a consequence, they are applied in fields as diverse as photovoltaics, photonics, bio-imaging, nano-sensing, and nano-electronics. Doping with transition metal impurity ions allows access to an entirely new portfolio of complementary physical properties in this class of materials.

Photoluminescence in doped semiconductor nanocrystals typically involves one of two general scenarios for relaxation after photoexcitation. The most extensively studied scenario is typified by Zn₁₋ₓMnₓSe and Zn₁₋ₓMnₓS nanocrystals, which frequently show PL quantum yields exceeding 50%. As phosphors, these nanocrystals are characterized by very large energy shifts between absorption and PL maxima arising from rapid nonradiative energy transfer from the excited semiconductor to the Mn²⁺ dopants. The excited dopants then relax radiatively via the ⁴T₁→⁶A₁ internal d-d transition with a slow decay (τ_{Mn}˜μsec−msec). The electronic structure responsible for this scenario is generalized in FIG. 2A, which is also applicable to numerous other doped semiconductor materials. A qualitatively different scenario is encountered in Mn²⁺-doped intermediate- or narrow-gap semiconductor nanocrystals such as Cd₁₋ₓMnₓSe and Cd₁₋ₓMnₓ Te, where the lowest excitonic states occur below all of the Mn²⁺d-d excited states (FIG. 2B) and excitonic PL is therefore not quenched by energy transfer to Mn²⁺. This scenario is conducive to exciton spin polarization and spontaneous magnetization of the Mn²⁺spins under the exciton's exchange field, as observed in colloidal Cd₁₋ₓMnₓSe nanocrystals. The scenarios from FIGS. 2A and 2B have both been studied extensively in the corresponding bulk, thin film, and self-assembled quantum dot forms of transition-metal-doped semiconductors.

Recently, a new relaxation scenario for photoexcited Mn²⁺-doped semiconductors was observed: small colloidal Cd₁₋ₓMnₓSe nanocrystals possessing electronic structures like that in FIG. 2A (with Mn²⁺ states within the gap) exhibited excitonic luminescence like in FIG. 2B. This luminescence was characterized by extremely long excitonic PL decay times of up to ˜15 μsec at 200 K, orders of magnitude longer than the intrinsic excitonic lifetimes. The slowly decaying Mn²⁺ excited state was shown to act as a population storage reservoir from which an excitonic population could be regenerated thermally, analogous to the classic E-type delayed fluorescence of organic chromophores involving singlet-triplet thermalization. Unfortunately, the small nanocrystal diameters (<−2.5 nm) needed to shift the CdSe excitonic states above the Mn²⁺⁴T₁ state approached the lower limit that could be doped, leading to signal “contamination” from undoped nanocrystals that obscured the effect. The PL arising from this unusual scenario constituted a minor fraction of the total PL, and was only clearly observed using gated detection at low temperatures. The need to balance size-dependent doping constraints against the size dependence of the nanocrystal energy gap ultimately limited dual emission in colloidal Cd₁₋ₓMnₓSe nanocrystals to a photophysical novelty.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a composition is provided. In one embodiment, the composition includes:

(a) a host material having a host luminescent state; and

(b) a luminescent dopant having a dopant luminescent state that is lower in energy than the host luminescent state;

wherein the luminescent dopant is in electronic communication with the host;

wherein the luminescent states of the host and the luminescent dopant are separated by an energy gap;

wherein the energy gap is sufficiently small that thermal energy is sufficient to bridge the energy gap;

wherein a luminescence lifetime of the dopant luminescent state is at least 10 times longer than a luminescence lifetime of the host luminescent state;

wherein the composition exhibits simultaneous luminescent emission at two distinct peak wavelengths, a first emission peak wavelength defined by the host luminescent state and a second emission peak wavelength defined by the dopant luminescent state; and

wherein the intensity of the first emission peak wavelength and the intensity of the second emission peak wavelength vary inversely in response to variations in thermal energy.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B are schematic representations of representative compositions in accordance with aspects of the present disclosure.

FIGS. 2A-2D. Schematic representation of different electronic structures related to photoluminescence in colloidal Mn²⁺-dopedsemiconductor nanocrystals. (A) When Mn²⁺states reside within the semiconductor gap, efficient energy transfer (k_{ET}) quenches excitonic emission and sensitizes Mn²⁺⁴T₁^{→6}A₁luminescence. (B) In narrower-gap semiconductors, all Mn²⁺ excited states are located outside of the gap, and the nanocrystals show excitonic luminescence. (C) TEM image of a colloidal Zn₁₋ₓMnₓSe/ZnCdSe core/shell nanocrystal, showing lattice fringes and pseudo-spherical shape, and schematic representation of the same. (D) Room-temperature electronic absorption and photoluminescence spectra of colloidal Zn₁₋ₓMnₓSe and Zn₁₋ₓMnₓSe/ZnCdSe nanocrystals. Core diameter=4.5 nm, x ˜0.01, shell thickness ˜0.6 nm.

FIGS. 3A-3D. Room-temperature absorption and photoluminescence data for (A) Zn₁₋ₓMnₓSe core and (B) Zn₁₋ₓMnₓSe/ZnCdSe core/shell nanocrystals. (C, D) Time evolution of the room-temperature photoluminescence for the same samples, plotted on a logarithmic intensity scale. Core diameter=4.5 nm, x ˜0.01, shell thickness ˜0.7 nm.

FIGS. 4A and 4B. (A) Summary of the relevant components of Zn₁₋ₓMnₓSe/ZnCdSe dual emission as described by Equation 1. (B) Simulated (left) and experimental (right, from FIG. 3D) evolution of the excitonic PL, plotted on a logarithmic intensity scale. The black lines are guides to the eye that trace the intensity maxima in time. Simulation parameters: ΔE(center)=0.32 eV, k_{Mn}=10⁴ sec⁻¹, k_{exc}=10⁸ sec⁻¹, k_{ET}=k_{BET}=5×10¹⁰ sec⁻¹, T=298 K, N_{exc}(0)=1. The bottom panels show simulated (left) and experimental (right) PL time slices at 10, 20, 35, and 70 μsec following the excitation pulse, plotted on a linear intensity scale. FIG. 4B compares the experimental PL time evolution with that calculated from Equation 1 using no adjustable parameters. The distribution of decay rates as a function of PL energy that leads to the blue-shifting PL maximum between FIGS. 3A and 3B is clearly captured by the model: nanocrystals that emit further in the blue have larger ΔE, which decreases their back energy transfer rates and thus leads to slower overall population decay. Although more highly parameterized rate equations reproduce the experimental results better, they do not provide a deeper understanding of the underlying physics. Instead, we conclude that the simple three-level model in Equation 1 captures the essence of the dual emission in these nanocrystals well.

FIGS. 5A-5C. (A) Variable-temperature photoluminescence spectra of colloidal Zn₁₋ₓMnₓSe/ZnCdSe nanocrystals collected in 20 K intervals and normalized to total integrated intensity, showing intensity transfer between Mn²⁺ and excitonic bands as a function of temperature. Inset: Photograph of the same nanocrystals at approximately 210 and 400 K. Core diameter=3.7 nm, x ˜0.01, shell thickness ˜0.4 nm. (B) Response curves for three colloidal Zn₁₋ₓMnₓSe/ZnCdSe nanocrystal samples, plotting I_{exc}/Iₜₒₜ vs temperature, and showing tunability of the active temperature window. From left to right: core diameter=4.5 nm, x=0.01, shell thickness ˜1.0 nm, core diameter=4.0 nm, x=0.01, shell thickness ˜0.6 nm, core diameter=3.7 nm, x=0.01, shell thickness ˜0.4 nm. (C) PL response to ±0.2° C. temperature oscillations of a re-circulating chiller with time-averaged sample temperature of 19.5° C., measured using dispersed halogen lamp excitation and a fiber-coupled hand-held spectrometer. The dashed line marks the point where the chiller was turned off and the sample was allowed to warm toward room temperature. Core diameter=4.5 nm, x˜0.01, shell thickness ˜0.7 nm.

FIG. 6. Variable-temperature PL spectra of colloidal Zn₁₋ₓMnₓSe/CdZnSe nanocrystals, normalized to total integrated intensity. Core 3.7 nm, x ˜0.01, shell ˜0.4 nm. The temperature was varied between 293 and 393 K for this data set.

FIG. 7. Variable-temperature PL data of colloidal Zn₁₋ₓMnₓSe/CdZnSe nanocrystals normalized by the total integrated intensity. Core 4.0 nm, x ˜0.01, shell ˜0.6 nm. The temperature was varied between 213 K and 373 K for this data set.

FIG. 8. Intensity ratio (I_{exc}/Iₜₒₜ) taken from the data shown in FIG. 6. The temperature was cycled three times between room and high temperature, demonstrating reproducibility.

FIG. 9. Temporal decay of the PL intensity of Zn₁₋ₓMnₓSe nanocrystals from FIG. 3A, measured at room temperature using a streak camera setup and a frequency-doubled Ti-Sapphire laser (λ_{exc}=380 nm). The instrument response function (IRF) measured at 380 nm is shown as a dotted line. The excitonic emission decays within <20 ps, as determined by a reconvolution fit of a biexponential decay (accounting for both the excitonic and trap decays) with the IRF. This fast decay is attributed to fast energy transfer to the Mn²⁺ dopants as disussed in the main text.

FIG. 10. Temperature dependence of the excitonic to total emission intensity ratio as a function of time. The emission ratio is stable and reproducible under continuous irradiation over 7 hours. The sample consists of a 3.7 nm core and a 0.4 nm CdSe shell nanoparticles suspended in toluene. The temperature was measured independently with a temperature probe inside the solution.

FIGS. 11A and 11B. Red shift of the first absorption feature associated with CdSe shell growth vs Cd/Zn ratio analytically determined using atomic emission ICP (A) and shell thickness calculated based on Cd/Zn ratio assuming a spherical geometry for the particles (B).

FIGS. 12A-12C. Dual-emitting Mn²⁺-doped semiconductor nanocrystals. (A) Wide-gap Mn²⁺-doped semiconductor nanocrystals such as Zn₁₋ₓMnₓSe and Zn₁₋ₓMnₓSe/ZnS show efficient sensitized Mn²⁺ luminescence following semiconductor photoexcitation. (B) Narrowing the band gap allows thermal population of excitonic excited states by back energy transfer from Mn²⁺ (⁴T₁), yielding excitonic PL in addition to Mn²⁺ PL (orange arrow). (C) (i) Core Zn₁₋ₓMnₓSe (d ˜3 nm) nanocrystals show intense sensitized Mn²⁺ PL at ˜590 nm, as well as some trap PL at ˜700 nm. (ii) Growth of a ˜3 monolayer ZnS shell around these cores increases the Mn²⁺ PL QY while eliminating surface trap PL. (iii) Growth of a ˜1 monolayer CdS shell around the Zn₁₋ₓMnₓSe/ZnS nanocrystals narrows the energy gap and causes the appearance of excitonic PL at ˜525 nm, with a drop in PL QY. (iv) Growth of a final ˜3 monolayer ZnS shell around the Zn₁₋ₓMnₓSe/ZnS/CdS nanocrystals narrows the energy gap slightly, altering the relative intensities of the two PL features. The final nanocrystals have d ˜6 nm and show intrinsic dual emission at room temperature with PL QYs up to ˜40%.

FIGS. 13A and 13B. Thermal stability. (A) Variable-temperature PL spectra of colloidal Zn₁₋ₓMnₓSe/ZnS/CdS/ZnS nanocrystals (d ˜7 nm, 39% QY at room temperature, capped with trioctylphosphine oxide), measured in octadecene under nitrogen. Spectra were normalized to total integrated intensity. (B) Thermometric response curve plotting I_{exc}/Iₜₒₜ vs temperature for these nanocrystals. A maximum slope of 7.3×10^{-3°} C. ⁻¹ was obtained.

FIGS. 14A-14D. Water-soluble dual-emitting nanocrystals. (A) Variable-temperature PL spectra of citrate-capped Zn₁₋ₓMnₓSe/ZnS/CdS/ZnS nanocrystals (d ˜5 nm) in water. Spectra were normalized to the total integrated intensity. Inset: Photograph of the nanocrystals in water (left) and in toluene (right). The QY dropped from 15% to 10% upon phase transfer. (B) Thermometric response curve plotting I_{ecx}Iₜₒₜ vs temperature for these nanocrystals. A maximum slope of 7.2×10⁻³ ° C.⁻¹ was obtained. (C) Variable-temperature PL spectra of Zn₁₋ₓMnₓSe/ZnS/CdS/ZnS nanocrystals encapsulated by n-octylamine-modified poly(acrylic) acid, suspended in aqueous solution. The QY dropped from 24% to 19% upon phase transfer. Inset: Photograph of these nanocrystals in toluene (left) and in aqueous solution (right). (D) Thermometric response curve plotting I_{exc}/Iₜₒₜ vs temperature for the polymer-encapsulated nanocrystals. A maximum slope of 8.3×10⁻³ ° C.⁻¹ was obtained.

FIG. 15. Left: schematic depiction of the growth of dual-emitting nanocrystals. Right: Corresponding absorption and emission spectra of these nanocrystals. (A) Core Zn₁₋ₓMnₓSe nanocrystals show a small first absorption feature near 390 nm and photoluminescence (PL) centered near 590 nm with a broad trap PL at lower energy (B) Addition of a ZnS shell to the core nanocrystals yields a small red-shift in the first absorption feature of the nanocrystals as well as a decrease in the trap PL (C) Growth of a CdS layer on the nanocrystals leads to a decrease in the energy gap resulting in a large (˜50 nm) shift of the first absorption peak and appearance of excitonic PL (D) The final ZnS layer results in some additional broadening of the absorption of the nanocrystals and a small decrease in the energy gap.

FIG. 16. Variable-temperature photoluminescence (PL) spectra of colloidal Zn₁₋ₓMnₓSe/ZnS/CdS/ZnS nanorods normalized by the total integrated PL intensity. The temperature was varied from −160° C. to 22° C. for this data set. As observed with the colloidal spherical samples, the excitonic PL peak centered near 540 nm increases as the temperature is increased while the Mn²⁺⁴T₁ PL peak centered near 590 nm decreases.

FIG. 17. Transmission electron microscopy image of colloidal Zn₁₋ₓMnₓSe/ZnS/CdS/ZnS rods for which the temperature dependent photoluminescence spectra are presented in FIG. 16. The rods have diameters of about 5 nm with lengths of about 50 nm.

FIG. 18. Absorption spectra of Zn_{1-x-y}CdₓMn_{y}Se nanocrystals during reaction progress. The energy of the first absorption feature of the nanocrystals red shifts over time. Aliquots were taken from the reaction medium at 8 minutes, 15 minutes, 23 minutes, and finally at 88 minutes.

FIG. 19. Transmission electron microscopy image of Zn_{0.874}Cd_{0.105}Mn_{0.021}Se nanocrystals. Short rods and dots are observed.

FIG. 20. Absorption and photoluminescence (PL) spectra of Zn_{1-x-y}CdₓMn_{y}Se nanocrystals before and after annealing. The absorption spectra are normalized to the first absorption feature. The PL spectra are normalized to the excitonic emission peak centered near 525 nm. The trap emission centered near 700 nm decreases during annealing while the excitonic emission intensity increases.

FIG. 21. X-ray diffraction spectra of Zn_{1-x-y}CdₓMn_{y}Se nanocrystals before and after annealing. There is little change observed before and after the annealing process. The spectra indicate the nanocrystals possess zinc blende structure and the peak positions fall close to those of pure ZnSe but shifted slightly towards those of pure CdSe.

FIG. 22. Variable-temperature photoluminescence (PL) spectra of colloidal Zn_{0.874}Cd_{0.105}Mn_{0.021}Se nanocrystals normalized by the total integrated PL intensity. The temperature was varied between 24° C. and 150° C. for this data set. The excitonic PL peak centered near 525 nm and the Mn²⁺⁴T₁ PL peak centered near 595 nm exhibit near equal emission intensities at 24° C. The excitonic PL peak increases as the temperature is raised while the Mn²⁺⁴T₁ PL peak decreases.

FIG. 23. Thermometric response curve plotting I_{exc}/Iₜₒₜ vs temperature for the nanocrystals shown in FIG. 22. A maximum slope of 6.7×10⁻³ ° C.⁻¹ was obtained.

FIG. 24. Absorption spectra of Zn_{1-x-y}CdₓMn_{y}Se nanocrystals with varying composition. The amount of cadmium within the particles as determined by inductively coupled plasma atomic emission spectroscopy is indicated. Generally, higher percentages of cadmium correspond to smaller band gap energies. Longer growth times resulting in larger nanocrystals can also lead to smaller band gap energies. The manganese composition ranged from 0.9% to 2.9% for these samples.

### DETAILED DESCRIPTION

A composition is provided comprising a host material and a luminescent dopant. The composition exhibits dual luminescent emission peaks, one each for the host material and the luminescent dopant. The intensity of the emission peaks varies as a result of the changing temperature of the composition. This quality enables the composition to be used for ratiometric optical thermometry, including exemplary applications, such as in situ temperature sensing.

In one embodiment, the composition includes:

(a) a host material having a host luminescent state; and

(b) a luminescent dopant having a dopant luminescent state that is lower in energy than the host luminescent state;

wherein the luminescent dopant is in electronic communication with the host;

wherein the luminescent states of the host and the luminescent dopant are separated by an energy gap;

wherein the energy gap is sufficiently small that thermal energy is sufficient to bridge the energy gap;

wherein a luminescence lifetime of the dopant luminescent state is at least 10 times longer than a luminescence lifetime of the host luminescent state;

wherein the composition exhibits simultaneous luminescent emission at two distinct peak wavelengths, a first emission peak wavelength defined by the host luminescent state and a second emission peak wavelength defined by the dopant luminescent state; and

wherein the intensity of the first emission peak wavelength and the intensity of the second emission peak wavelength vary inversely in response to variations in thermal energy.

The host material and the luminescent dopant are in electronic communication, such that electronic energy can be exchanged between the two. This arrangement typically occurs when the luminescent dopant is disposed within the host material.

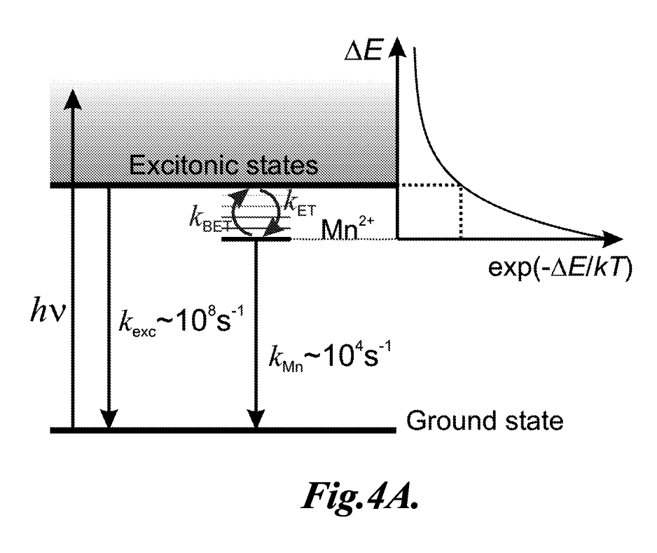

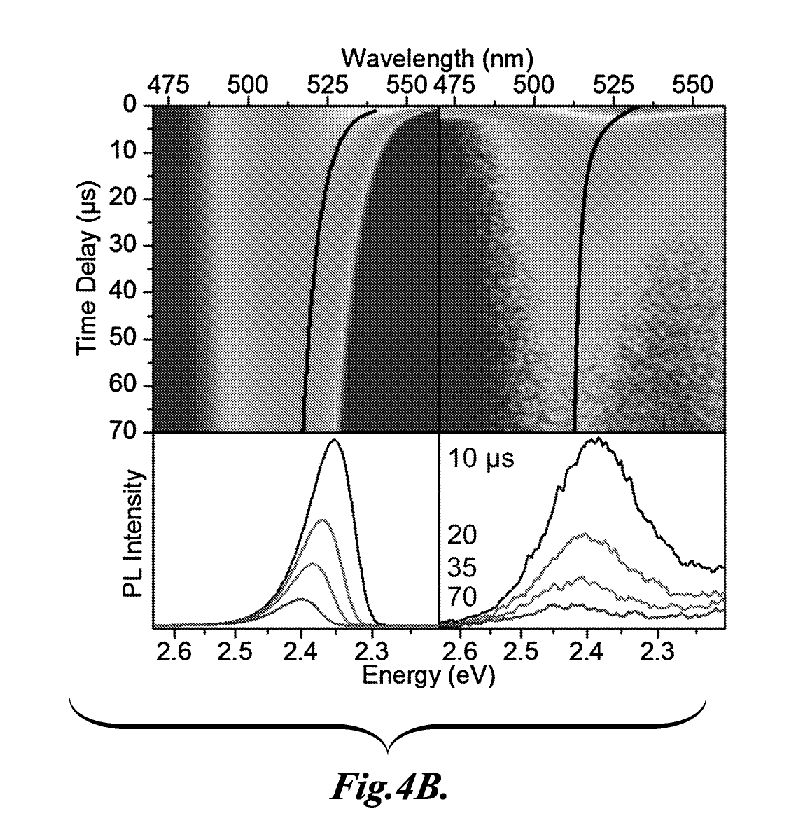

The host material has a host luminescent state and the luminescent dopant has a dopant luminescent state. The two luminescent states are at different energy levels, which results in luminescent emission from each material at different wavelengths. The dopant luminescent state is at a lower energy than the host luminescent state, as illustrated in FIG. 4A.

Referring to FIG. 4A, the host luminescent state is labeled as “Excitonic states” and the dopant luminescent state is labeled as “Mn²⁺”. These labels result from the exemplary composition for which the figure is modeled: a semiconductor host material and Mn²⁺ as the luminescent dopant. It will be appreciated that not every embodiment will have the electronic states illustrated in FIG. 4A, because the composition of the host material and luminescent dopant can vary and will determine the relevant energies.

Referring still to FIG. 4A, in the composition an energy gap exists between the host luminescent state and the dopant luminescent state. The energy gap is sufficiently small that thermal energy is sufficient to bridge the energy gap. This is schematically illustrated by the variables k_{BET} and k_{ET} in FIG. 4A, which represent energy transfer across the energy gap to the host luminescent state from the dopant luminescent state and back, respectively. The nature of energy transfer across the energy gap is such that even small (e.g., less than 1° C.) changes in temperature affect the luminescent states. This change can be quantitatively measured optically through emission intensity. Both the dopant luminescent state and the host luminescent state emit light, but the nature of the effect of temperature change on the luminescent states is such that changing temperature affects the luminescent states inversely. For example, in Example 1, the exemplary composition, Zn₁₋ₓMnₓSe/ZnCdSe core/shell nanocrystals, exhibits increasing photoluminescent intensity of the higher energy host material as the temperature increases. Conversely, the lower energy luminescent guest exhibits decreasing photoluminescent intensity as the temperature rises.

In one embodiment, the energy gap is from about 0.5 electron volts to about 0.0013 electron volts.

In one embodiment, the thermal energy is provided by a temperature of from about 0 kelvin to about 700 kelvin. The temperature is measured at the composition itself, as the immediate environment of the composition may have a different temperature than the ambient temperature (e.g., due to increased temperature from illumination providing the photoexcitation).

In one embodiment, the luminescence lifetime of the dopant luminescent state is at least 1000 times longer than the luminescence lifetime of the semiconductor luminescent state. The longer lifetime of the dopant allows for more time for back energy transfer (smaller k_{BET}) to occur. Thus, compositions may have larger energy gaps. In one embodiment, the composition has a luminescent quantum yield of at least 10%. Large quantum yields increase the signal-to-noise ratio enhancing the utility of the composition for generating an optical read out of local temperature.

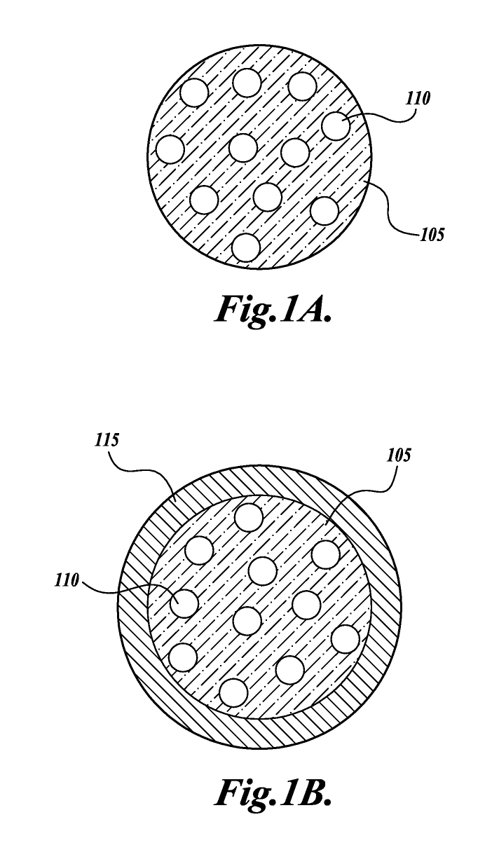

The host material and the luminescent dopant can be any two different materials that meet the listed criteria. Referring to FIG. 1A, a schematic illustration of a representative composition is provided. The composition is primarily comprised of the host material 105, and a plurality of luminescent dopants 110 are disposed therein. It will be appreciated that the embodiment illustrated in FIG. 1A is only a schematic representation used to convey the basic aspects of the composition. The composition is in no way limited to a spherical host material 105 or spherical luminescent dopants 110. As will be discussed further below, the composition, host material, and luminescent dopant can take on many forms.

Referring to FIG. 1B, a second schematic illustration of a representative composition is provided, which includes a shell 115 disposed surrounding the host material 105 containing a plurality of luminescent dopants 110. As will be discussed in further detail below, a shell 115 can be monolithic (as illustrated) or formed from a plurality of shells. The function of the shell can be to affect the luminescent properties of the composition, provide a non-luminescence-altering function (e.g., water solubility), or a combination thereof.

In certain embodiments, the host material is a semiconductor. Semiconductors typically have an excitonic luminescent state, which is the host luminescent state in the context of the present embodiments.

In one embodiment, the host material is a wide-gap semiconductor. As used herein, the term “wide-gap” semiconductor is a semiconductor material (e.g., an inorganic semiconductor) having a relatively large band gap. For the purposes of the present disclosure, wide-gap semiconductors have a band gap greater than 2.0 electron volts, which excludes common semiconductors such as silicon and gallium arsenide.

In certain embodiments, the host material is a single semiconductor material, such as silicon. However, in other embodiments, the host material is a compound semiconductor, formed from materials in at least two different groups of the periodic table.

In a further embodiment, the host material comprises a plurality of semiconductor components selected from the group consisting of zinc, cadmium, selenium, sulfur, tellurium, oxygen, gallium, arsenic, indium, phosphorous, nitrogen, tin, germanium, silicon, and carbon. It will be appreciated that while not all of these components are semiconductors in their elemental state, they are capable of forming compound semiconductors.

As described in Examples 1 and 2, the composition can be formed by combining several materials sequentially in order to produce the required luminescence energetics.

In these Examples, a core (e.g., ZnSe) host material is provided that has a luminescent dopant (e.g., Mn²⁺). One or more shells are provided around the core so as to improve the energetics and material properties of the formed composition. Accordingly, in certain embodiments the host material has a core and a shell, each of which has a different composition. The shell may comprise a plurality of shells. The function of the shell may be to improve the luminescent characteristics of the composition, or may provide other beneficial characteristics, such as water solubility, targeting functionalization, and the like.

In certain embodiments, the luminescent dopant is entirely contained within the core. In certain other embodiments, the luminescent dopant is distributed throughout the core and the shell or only within the shell.

In certain embodiments, the compound semiconductor is an alloy, as described in Example 3. Using an alloy allows for a single reaction vessel to be used to synthesize the composition in certain embodiments. Furthermore, an alloy can be formed in many cases that includes the benefits of core-shell compositions made from similar materials. Accordingly, in certain embodiments alloys of the composition are more efficient to produce than core-shell compositions.

In one embodiment, the composition comprises an alloy of zinc, cadmium, manganese, and selenium. In a further embodiment, the composition is Zn_{1-x-y}CdₓMn_{y}Se, wherein x is from about 0.01 to about 0.5 and y is from about 0 to about 0.2.

The luminescent dopant is disposed in proximity to the host material such that the two are in electronic communications. In certain embodiments, the luminescent dopant is disposed within the host material. As used herein, the term “dopant” refers to any material that is not the host material, including impurity atoms, molecules, or defects. The dopant may be intentionally introduced into the host material or may be naturally occurring in the host material.

In one embodiment, the luminescent dopant is a transition metal.

In one embodiment, the luminescent dopant is a lanthanide.

As disclosed in the Examples, in certain embodiments the luminescent dopant is an ion of manganese, such as Mn²⁺.

Typically, the shape and/or state of the host material defines the shape and/or state of the overall composition because the luminescent dopant is only present in the composition as a minority component. The composition can essentially take on any shape known to those of skill in the art.

Regarding the shape of the composition and/or host material, in one embodiment, the shape is a nanoparticle, as defined by having at least one dimension measuring 100 nm or less. In one embodiment, the shape selected from the group consisting of an irregular or regular particle, a sphere, a rod, a faceted polyhedron, a cube, a tetrapod, a branched structure, a dumbbell, and a bullet. In one embodiment, the host material is amorphous. In one embodiment, the host material is a powder. In one embodiment, the host material is a film.

The composition can be used for optical thermometry, as described in the Examples below. Certain advantages to using the composition instead of known materials include high temperature sensitivity, the ability to form nanoparticles, and the ability to functionalize the surface for solubility and/or targeting.

The following examples are included for the purposes of illustrating, not limiting, the embodiments disclosed herein.

### EXAMPLES

### Example 1

### Zn₁₋ₓMnₓSe/ZnCdSe Core/Shell Nanocrystals

In this example, we demonstrate pronounced dual emission from colloidal Mn²⁺-doped semiconductor nanocrystals at high temperatures, achieved using Zn₁₋ₓMnₓSe/ZnCdSe core/shell nanocrystals. With these core/shell nanocrystals, the two criteria of nanocrystal doping and energy-gap tuning are no longer interdependent and hence can be optimized individually: the initial preparation of Zn₁₋ₓMₓSe cores can be optimized for dopant incorporation, and subsequent CdSe shell growth can be optimized for dual emission. Surface termination with additional ZnSe layers was found to improve quantum yields and photostability. With this strategy, dual emission has been achieved as the dominant PL feature of colloidal semiconductor nanocrystals.

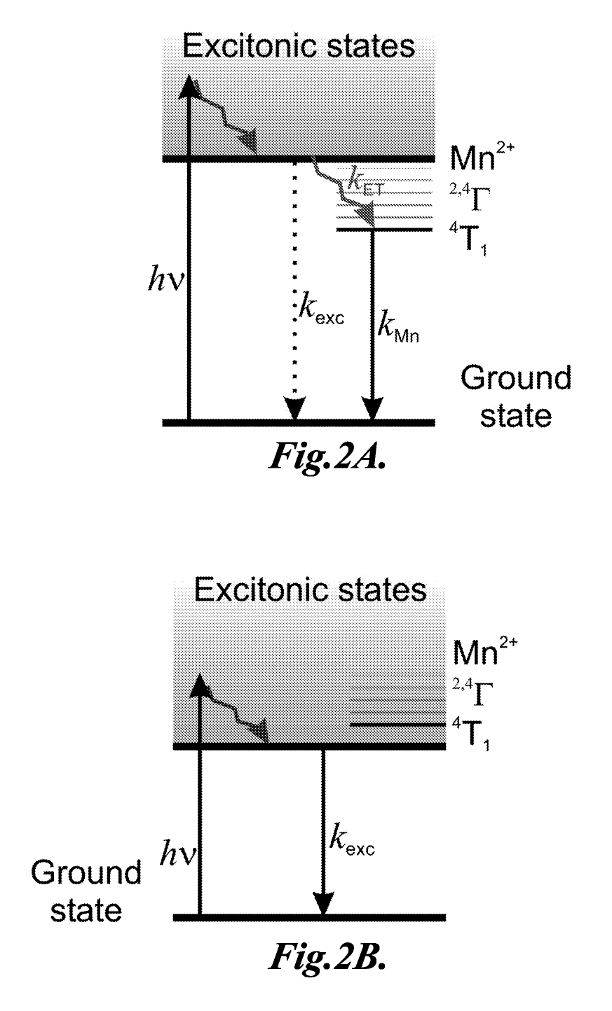

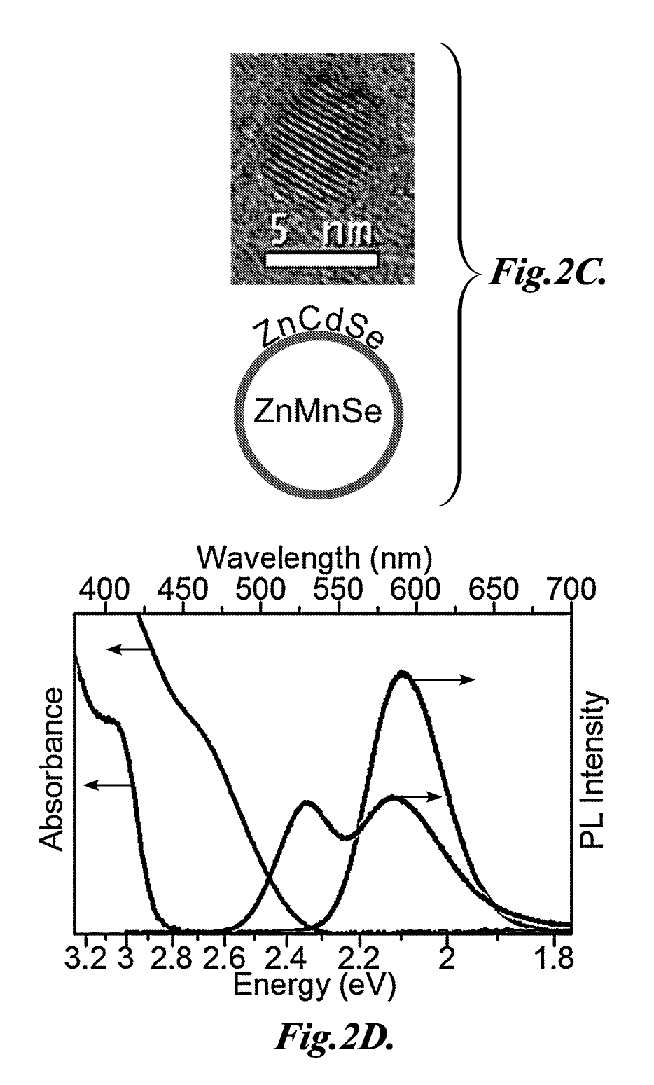

Zn₁₋ₓMnₓSe core nanocrystals (FIG. 2C) were prepared and characterized as described below (see Methods). ZnCdSe shell growth around Zn₁₋ₓMnₓSe cores allows the energy gap to be tuned continuously from ˜3.0 to ˜2.0 eV. FIG. 2D compares the room-temperature absorption and PL spectra of representative colloidal Zn₁₋ₓMnₓSe and Zn₁₋ₓMnₓSe/ZnCdSe nanocrystals. PL from the Zn₁₋ₓMnₓSe nanocrystals is dominated by the Mn²⁺⁴T₁→⁶A₁ band at 2.12 eV, and excitonic PL at ˜2.9 eV is almost completely suppressed, as described by FIG. 2A. Shell growth shifts the nanocrystal absorption edge lower by ˜0.5 eV. Remarkably, this red shift results in the appearance of a second emission band ˜0.25 eV higher in energy than the Mn²⁺ band, attributable to excitonic PL.

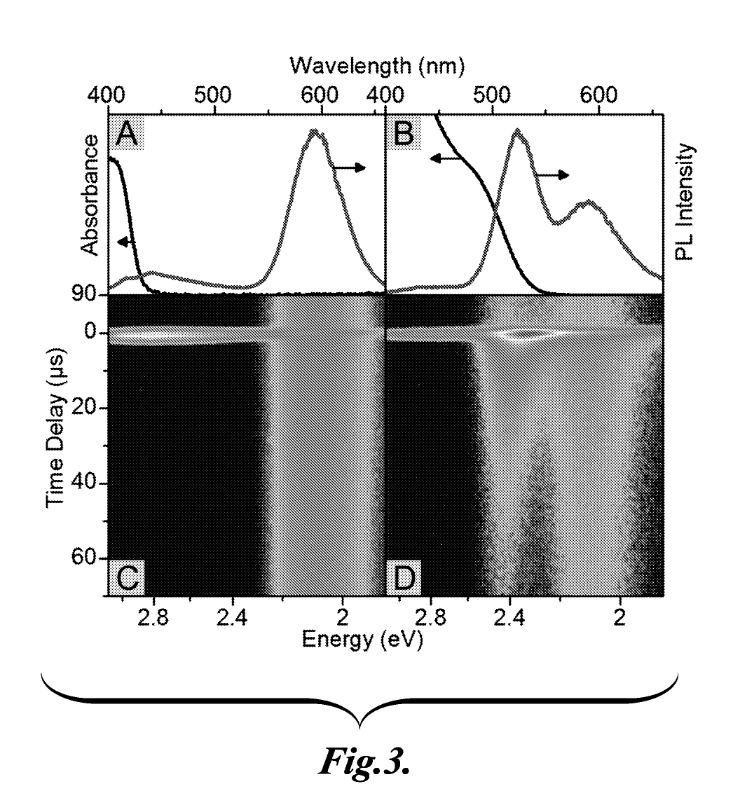

To probe the relationship between the two PL bands of the core/shell nanocrystals, excited-state dynamics were examined. FIGS. 3A and 3B show room-temperature PL spectra of core and core/shell nanocrystals measured using pulsed excitation with continuous signal integration, and FIGS. 3C and 3D show the time-resolved PL of the same samples. In the Zn₁₋ₓMnₓSe nanocrystals (FIGS. 3A and 3C), the Mn²⁺⁴T₁ PL shows a slow decay that exceeds the interval between excitation pulses. From FIG. 3C, τ_{Mn} is on the order of 100 μsec at room temperature. From independent measurements, the excitonic PL decays with a time constant of <20 psec, consistent with fast energy transfer to Mn²⁺ measured in related samples. A weak background signal is also observed over the entire window that decays within a few nanoseconds and is attributed to traps. Relative to the core nanocrystals, the excitonic PL decay time is greatly elongated and the Mn²⁺⁴T₁ decay time is shortened in the core/shell nanocrystals (FIG. 3D). FIG. 3D also reveals that the excitonic PL maximum shifts to higher energies with time. Growth of just a thin shell layer thus alters the nanocrystal PL dramatically.

In both the Zn₁₋ₓMnₓSe and Zn₁₋ₓMnₓSe/ZnCdSe nanocrystals, band-to-band photoexcitation is followed by rapid energy transfer to the lower-energy Mn²⁺ excited state. The dual emission and unusual PL dynamics of the Zn₁₋ₓMnₓSe/ZnCdSe nanocrystals are interpreted as arising from thermally assisted population transfer from this ⁴T₁ state back to the higher-energy excitonic state. The Mn²⁺⁴T₁→⁶A₁ transition is spin forbidden and has a decay rate constant ˜10³-times smaller than that of the excitonic PL. Consequently, thermal exciton population of only one part in ˜10³ is sufficient to make excitonic and Mn²⁺ PL intensities equivalent. To test this interpretation, the time-dependent PL was modeled using coupled linear rate equations (Equation 1) that describe population evolution within the three-level scheme depicted in FIG. 4A. N_{Mn*} and N_{exc} refer to the populations of the Mn²⁺⁴T₁ and excitonic states, respectively, and k_{Mn} and k_{exc} are the decay rate constants associated with these excited states in the absence of coupling. k_{ET} and k_{BET} describe exciton-dopant energy transfer rate constants to and from the Mn²⁺, respectively. When k_{ET} and k_{BET} are fast relative to all others, Equation 1 converges to a thermal equilibrium model. All rate constants are effective values, and their dependence on the number and distribution of Mn²⁺ ions, or nonradiative loss pathways, is not explicitly parameterized.

$$\begin{matrix}\frac{d {N}_{{Mn}^{*}}}{d t} = {k}_{ET} {N}_{exc} - ( {k}_{Mn} + {k}_{BET} exp ( - \frac{Δ E}{kT} ) ) {N}_{{Mn}^{*}} & ( 1 a ) \\ \frac{d {N}_{exc}}{d t} = - ( {k}_{exc} + {k}_{ET} ) {N}_{exc} + {k}_{BET} exp ( - \frac{Δ E}{kT} ) {N}_{{Mn}^{*}} & ( 1 b )\end{matrix}$$

The remaining parameters in Equation 1 are the energy gap between excitonic and Mn²⁺⁴T₁ excited states (ΔE, using the Mn²⁺ origin at 2.263 eV) and the thermal free energy (kT). The nanocrystal samples studied here possess finite size and shell-thickness distributions that translate into distributions in ΔE and prove invaluable for understanding the effect. To simulate the data in FIG. 3D, the distribution in ΔE was set equal to the experimental intensity distribution of the first excitonic absorption feature.

k_{Mn} and k_{exc} are readily estimated from experiment, but k_{ET} and k_{BET} are more difficult to determine. A lower bound of k_{ET} ˜5×10¹⁰ sec⁻¹ (<20 psec) is obtained from streak camera measurements on the Zn₁₋ₓMn₁₋ₓSe nanocrystals of FIGS. 3A and 3C. Rate constants for energy transfer in the opposite direction (k_{BET}) have never been measured, but must also greatly exceed k_{Mn} for dual emission to be observed. To simulate the data in FIG. 3D, k_{ET} and k_{BET} were taken to be equal, with the back energy transfer rate attenuated by the appropriate Boltzmann factor.

FIG. 4B compares the experimental PL time evolution with that calculated from Equation 1 using no adjustable parameters. The distribution of decay rates as a function of PL energy that leads to the blue-shifting PL maximum in FIG. 3B is clearly captured by the model: nanocrystals that emit further in the blue have larger ΔE, which decreases their back energy transfer rates and thus leads to slower overall population decay. Although more highly parameterized rate equations reproduce the experimental results better, they do not provide a deeper understanding of the underlying physics. Instead, we conclude that the simple three-level model in Equation 1 captures the essence of the dual emission in these nanocrystals well.

Pronounced dual emission is rare in colloidal semiconductor nanocrystals, but is well known in molecules. The most structurally similar example is Mn²⁺/Eu³⁺-codoped ZnS nanocrystals, which show two independent PL features from the two separate dopants. Photophysically more similar are the molecular examples of exciplex or excimer complexes, and fluorescence/phosphorescence in organics, which both involve population transfer between two excited states. Among all known dual emitters, however, the nanocrystals described here are unique in that the temperatures over which their dual emission occurs can be easily tuned through nanocrystal size or composition control, which tunes ΔE. This dual emission is otherwise largely insensitive to environmental perturbation and is robust against photodegradation. Collectively, such properties make these dual-emitting doped nanocrystals superb probes for ratiometric optical thermometry. Colloidal semiconductor nanocrystals are already applied for optical thermometry in many fields, but accuracy relies on total intensity measurements that are susceptible to error introduced by optical occlusion, concentration inhomogeneities, excitation power fluctuations, or environment-induced nonradiative relaxation. Ratiometric detection involving two inter-converting excited states of the same nanocrystals circumvents these complications.

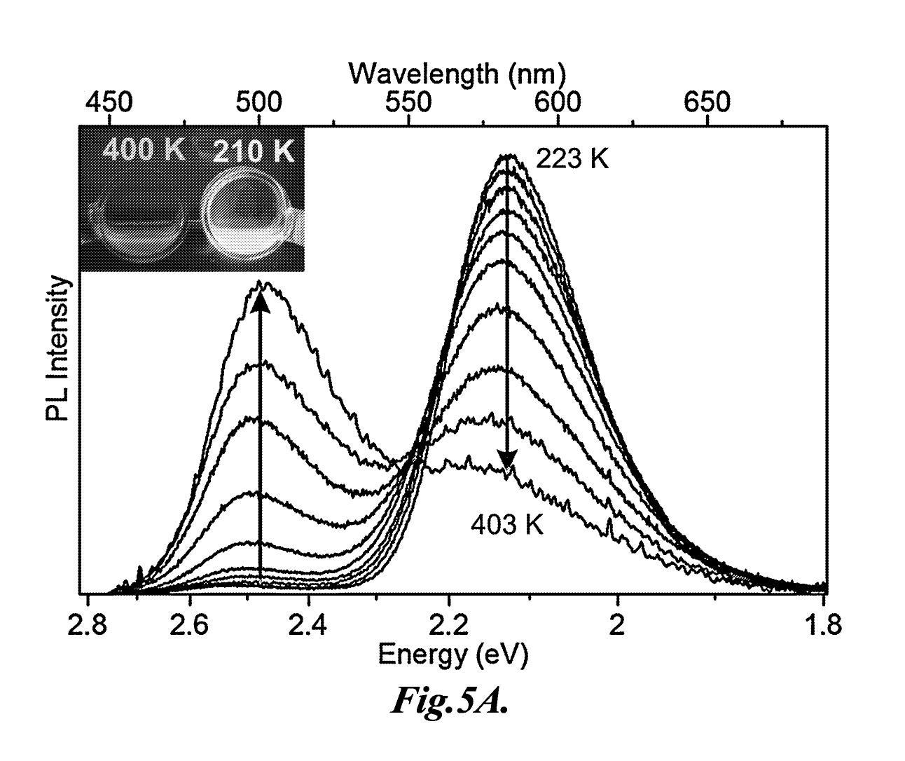

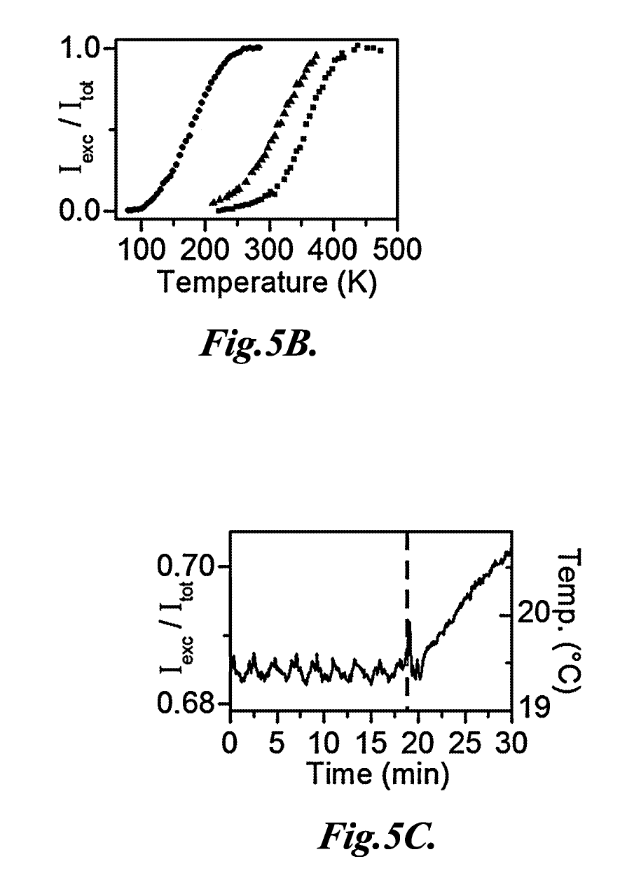

To demonstrate, FIG. 5A shows PL spectra of Zn₁₋ₓMnₓSe/ZnCdSe nanocrystals collected at various temperatures in the physiologically relevant window between 223 and 403 K, and normalized to the total integrated PL intensity at each temperature. At 223 K, the PL spectrum is dominated by the Mn²⁺⁴T₁→⁶A₁ ligand-field PL at 2.1 eV. Above ˜310 K, the excitonic PL grows in at ˜2.3 eV, and at 403 K the PL is almost exclusively excitonic. Photographs of these nanocrystals at the two extremes of this range are shown in the inset, one yielding green PL and the other yellow. The overall PL intensity decreases by a factor of ˜7 over this temperature range, characteristic of thermally activated nonradiative relaxation, but the normalized data show an isostilbic point at 2.2 eV. Invariant nonradiative contributions are required for observation of isostilbic points in PL spectra, and the isostilbic point in FIG. 5B thus indicates that nonradiative deactivation in these nanocrystals affects both PL intensities simultaneously and is accounted for by normalization. This result confirms the limit of fast energy transfer in Equation 1. Overall, these data demonstrate population transfer from one emissive excited state to the other as a function of temperature. Within the active dual-emission window, each temperature yields a unique PL spectrum characterized by its ratio of excitonic to Mn²⁺ PL intensities.

A calibration curve can be compiled from the data in FIG. 5A by plotting the ratio of integrated excitonic to total PL intensities (I_{exc}/Iₜₒₜ where Iₜₒₜ=I_{exc}+I_{Mn}) vs temperature (FIG. 5B). This curve demonstrates a high thermometric sensitivity with a maximum slope of 9×10⁻³ K⁻¹. Furthermore, the temperature window over which dual emission occurs can be tuned simply by changing AE during growth. The experimental calibration curves for two additional Zn₁₋ₓMnₓSe/ZnCdSe nanocrystal samples with different ΔE values are included in FIG. 5B for comparison. The ability to tune the active dual-emission temperature range by simple changes in growth conditions makes this dual emission attractive as the basis of a new array of optical temperature sensors. For demonstration, FIG. 5C shows a ±0.2° C. oscillation around the set temperature of a closed-cycle chiller detected using the nanocrystals from FIG. 2D, for which a signal-to-noise ratio of ˜10 was achieved using simple instrumentation (see Methods). The work with Mn²⁺-doped nanocrystals reported here is by no means comprehensive. Apart from the Mn²⁺ doping itself, these nanocrystals are essentially indistinguishable from others that have already been applied in biological imaging, microelectronics, thermal therapeutics, or photonics experiments. Using these dual-emitting nanocrystals, such applications can now readily provide in situ temperature data. Furthermore, this Mn²⁺-exciton dual emission is not limited to these core/shell nanocrystals, or even to nanocrystals, but should be generally achievable in other Mn²⁺-doped semiconductors grown to make ΔE<˜8 kT (e.g., Cd_{1-x-y}ZnₓMn_{y}Se, Cd₁₋ₓMnₓS, Zn₁₋ₓMnₓTe, etc.), offering even broader application opportunities.

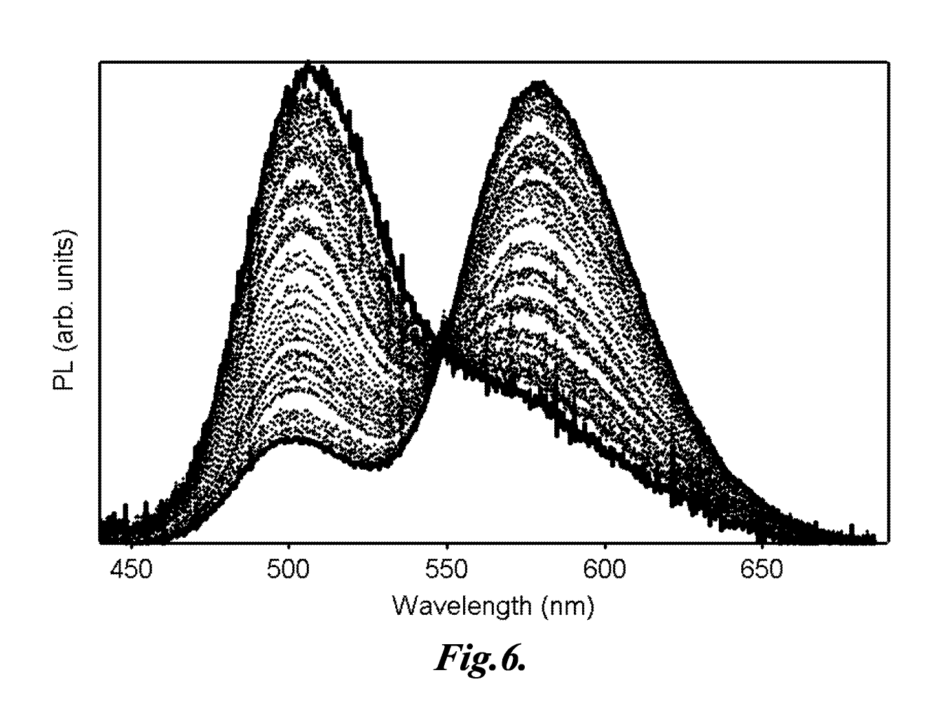

FIG. 6 illustrates variable-temperature PL spectra of colloidal Zn₁₋ₓMnₓSe/CdZnSe nanocrystals, normalized to total integrated intensity. Core 3.7 nm, x ˜0.01, shell ˜0.4 nm. The temperature was varied between 293 and 393 K for this data set.

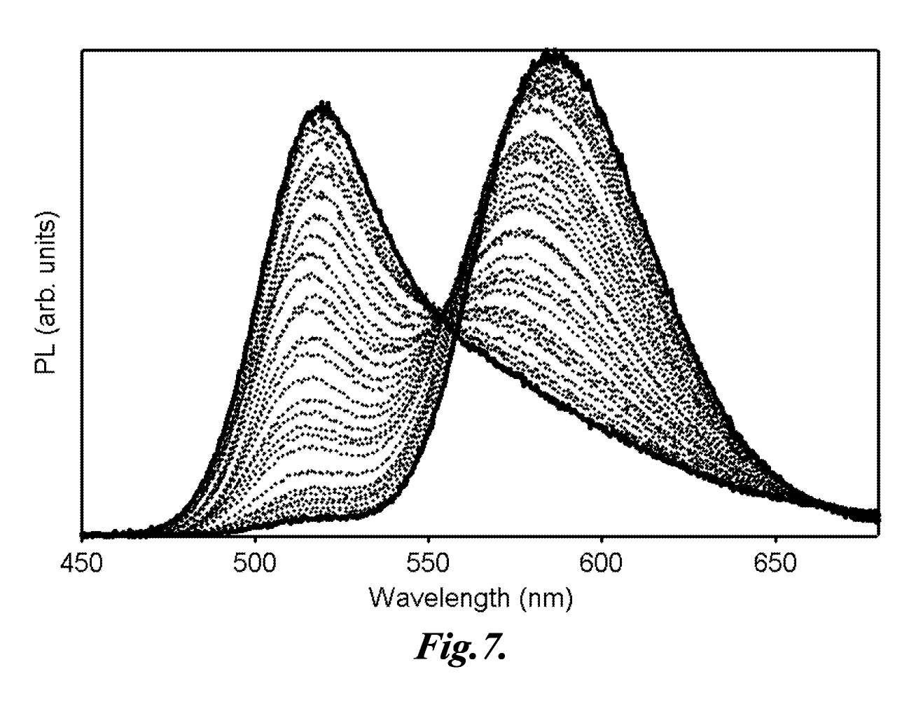

FIG. 7 illustrates variable-temperature PL data of colloidal Zn₁₋ₓMnₓSe/CdZnSe nanocrystals normalized by the total integrated intensity. Core 4.0 nm, x ˜0.01, shell ˜0.6 nm. The temperature was varied between 213 K and 373 K for this data set.

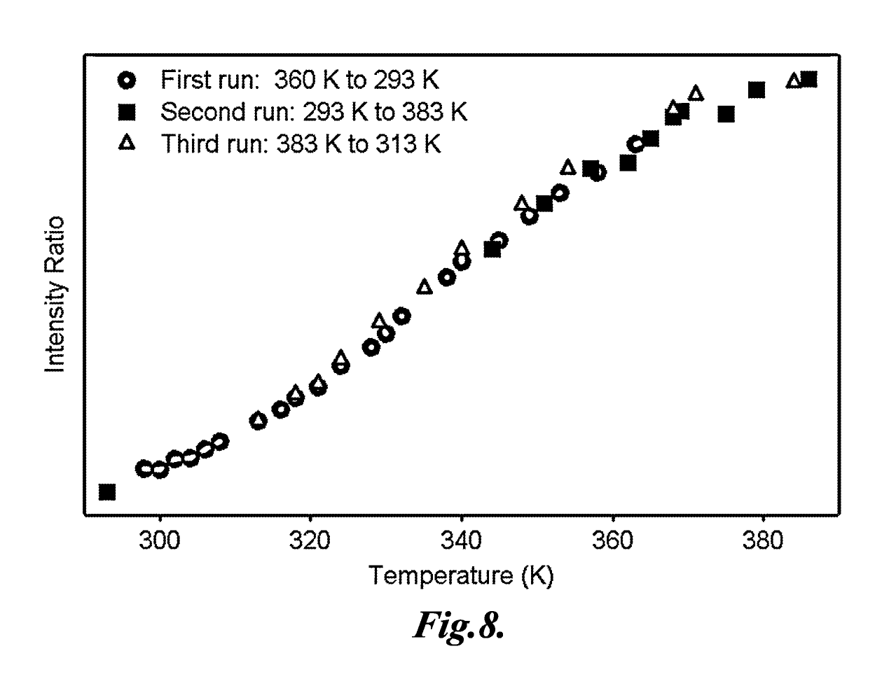

FIG. 8 illustrates intensity ratio (I_{exc}/Iₜₒₜ) taken from the data shown in FIG. 6. The temperature was cycled three times between room and high temperature, demonstrating reproducibility.

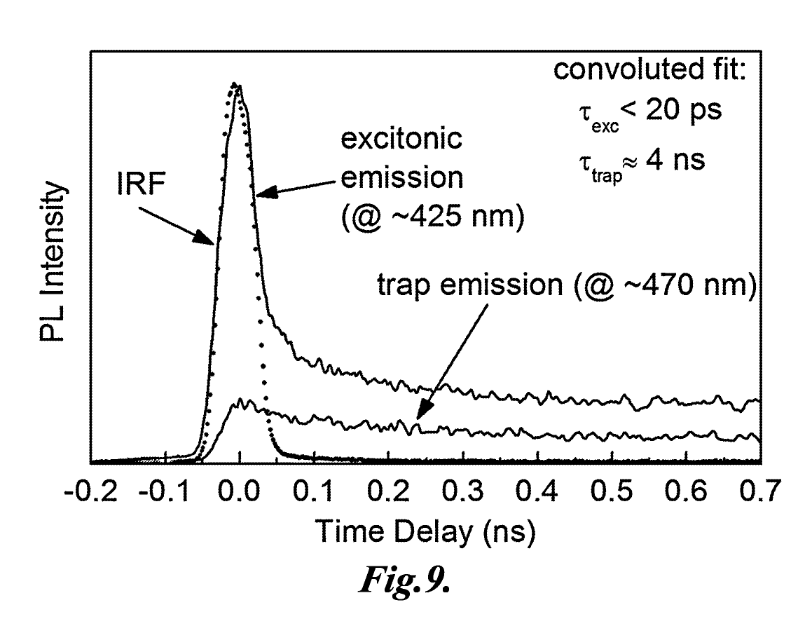

FIG. 9 illustrates temporal decay of the PL intensity of Z₁₋ₓMnₓSe nanocrystals from FIG. 3A, measured at room temperature using a streak camera setup and a frequency-doubled Ti-Sapphire laser a λ_{exc}=380 nm). The instrument response function (IRF) measured at 380 nm is shown as a dotted red line. The excitonic emission decays within <20 ps, as determined by a reconvolution fit of a biexponential decay (accounting for both the excitonic and trap decays) with the IRF. This fast decay is attributed to fast energy transfer to the Mn²⁺ dopants as disussed in the main text.

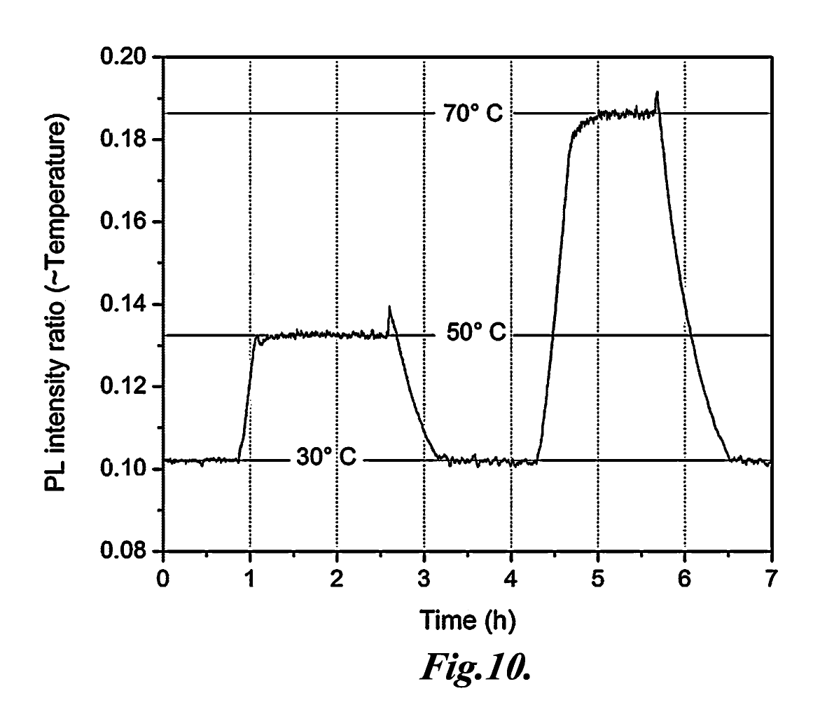

FIG. 10 illustrates temperature dependence of the excitonic to total emission intensity ratio as a function of time. The emission ratio is stable and reproducible under continuous irradiation over 7 hours. The sample consists of a 3.7 nm core and a 0.4 nm CdSe shell nanoparticles suspended in toluene. The temperature was measured independently with a temperature probe inside the solution.

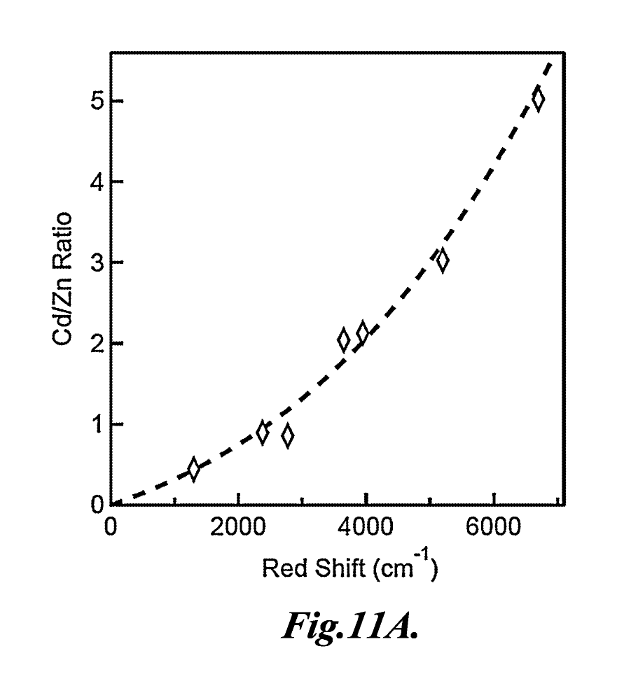

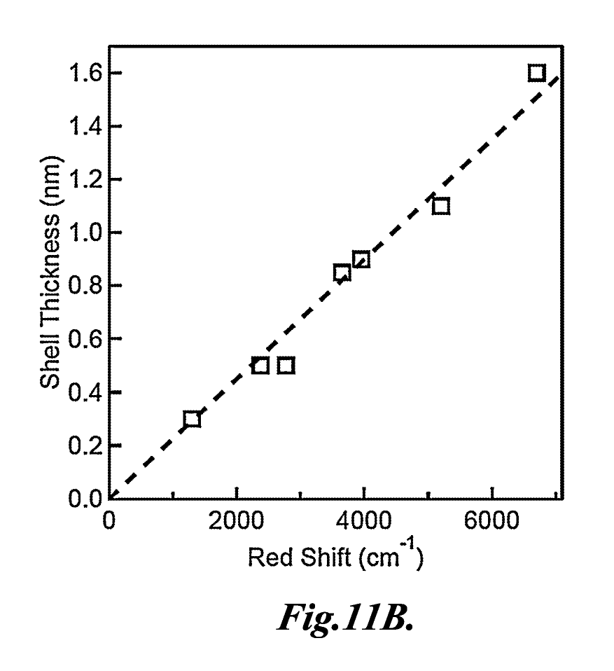

FIGS. 11A and 11B illustrate red shift of the first absorption feature associated with CdSe shell growth vs Cd/Zn ratio analytically determined using atomic emission ICP (A) and shell thickness calculated based on Cd/Zn ratio assuming a spherical geometry for the particles (B).

Methods

Synthesis and basic characterization. The inorganic precursor used in the synthesis of Zn₁₋ₓMnₓSe nanocrystals, (Me₄N)₂[Zn₄(SePh)₁₀], was prepared following procedures adapted from ref. 3. Zn₁₋ₓMnₓSe nanocrystals were synthesized from this cluster as follows: In a three-neck flask, hexadecylamine (10.8 g) and MnCl₂.4H₂O (0.01 g) were heated at 130° C. under vacuum for 90 minutes. The temperature was dropped to 80° C. and the solution placed under nitrogen. With a nitrogen over-pressure, the cluster (0.2 g) and elemental Se (0.02 g) were added to the reaction. The flask was quickly evacuated and refilled with nitrogen three times, and the reaction temperature was allowed to recover to 130° C. After stirring for 90 minutes, the temperature was ramped to 280° C. Nanocrystal growth was complete within 60 to 120 minutes, depending on the desired size. Unreacted precursors were removed by repeated precipitation of the product nanocrystals with ethanol and resuspension in toluene. These conditions were chosen to yield ˜1% Mn²⁺ incorporation into the nanocrystals, based on previous experience.

For addition of CdSe to the nanocrystal surfaces, core particles suspended in a small amount of toluene (0.01 mmol, determined by absorption) were added to a three-neck flask containing 4 g of octadecene and 0.5 g of oleylamine. The reaction flask was kept under vacuum at 100° C. for 30 minutes. Under a nitrogen atmosphere, the reaction was heated to 200° C., at which point an ODE solution containing 0.05 M cadmium oleate/Se and 0.5 g of trioctylphosphine was added to the nanocrystal suspension slowly until the desired energy gap was achieved. These particles were washed by repeated precipitation with ethanol and resuspension in toluene.

Addition of a ZnSe outer shell layer was found to improve PL quantum yields and photostability. Addition of a ZnSe shell to the nanocrystal surfaces: core particles suspended in 2 g of hexadecylamine and 2 g of trioctylphosphineoxide were heated to 200° C. A 0.05 M solution of zinc stearate and TOP/Se in ODE was added over the course of two hours to reach the desired shell thickness.

Absorption spectra of the colloidal nanocrystals were collected using a Cary 500 (Varian) spectrophotometer. TEM images were obtained using an FEI TECNAI F20, 200 kV transmission electron microscope.

Continuous-wave photoluminescence measurements. Room- and low-temperature continuous-wave PL measurements were performed on colloidal suspensions of nanocrystals in toluene, sealed in quartz tubes under nitrogen atmosphere. Low-temperature spectra were obtained using Ar⁺ ion laser excitation (457.9 nm, <˜10 mW), with frozen suspensions (glassy matrices) of colloidal nanocrystals cooled by helium vapor in a Janis STVP-100 optical cryostat. The PL was dispersed using a 0.5 m single spectrometer (150 grooves/mm grating blazed at 500 nm) and detected with a liquid-nitrogen-cooled charge-coupled. High-temperature continuous-wave photoluminescence data were collected with nanocrystals suspended in octadecene under nitrogen in a three-neck flask. A hand-held UV lamp was used as the excitation source, and a USB2000 Miniature Fiber Optic Spectrometer (Ocean Optics) was used for detection. The data in FIG. 5C were collected with the sample in a 1 cm×1 cm cuvette cooled by a recirculating water chiller to a time-averaged sample temperature of 19.5° C. The sample was excited using a dispersed halogen lamp, and the PL was detected using a USB2000 Miniature Fiber Optic Spectrometer (Ocean Optics).

Time-resolved photoluminescence measurements. All time-resolved photoluminescence measurements were performed on colloidal suspensions in toluene sealed in quartz tubes under nitrogen atmosphere. Samples were excited by the frequency doubled output of a mode-locked Ti:Sapphire oscillator at 3.26 eV, well above their fundamental band-edge absorption energies. The repetition rate of the Ti:Sapphire output was slowed from 76 MHz to 9 kHz using a pulse picker. The pulse duration was on the order of 150 fs, and the instrument response on the order of 50 ps. Data were collected using a streak camera combined with a grating spectrometer.

### Example 2

### Dual Emission Multi-Shell Semiconductor Nanocrystals

In the present Example, multi-shell semiconductor nanocrystals have been synthesized that display intrinsic dual emission with robust photo- and thermal stability and attractive thermal sensitivity. Dual emission is demonstrated following phase transfer into aqueous media. These nanocrystals are suitable for diverse optical thermometric or thermographic applications in biotechnology or other areas.

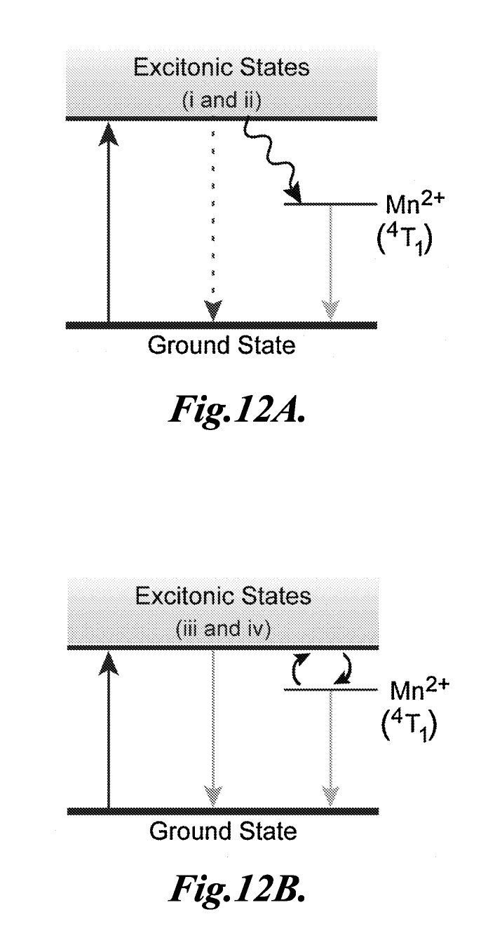

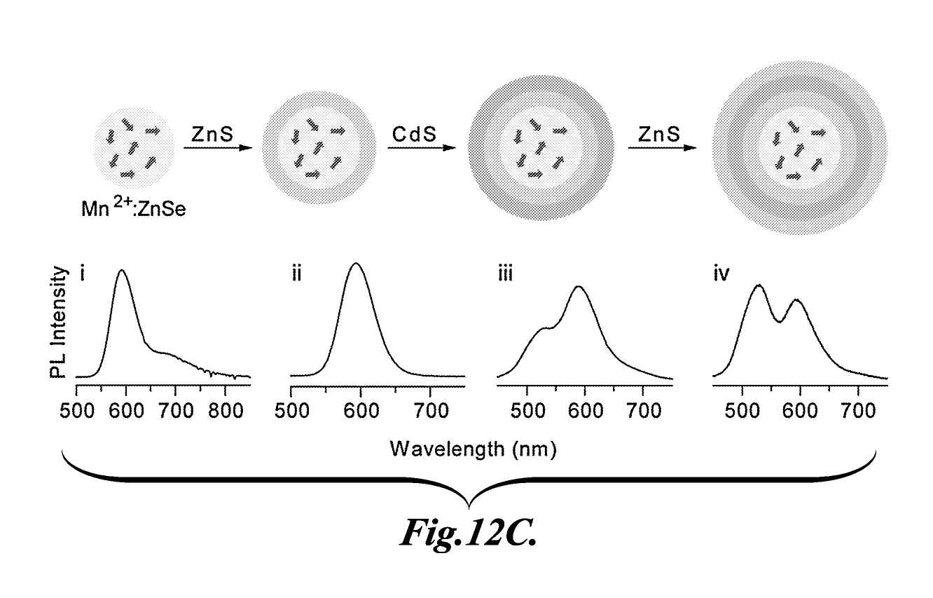

As disclosed in Example 1, a new photophysical process by which nanocrystals show intrinsic dual emission was provided. When Mn²⁺ ions were doped into wide-gap semiconductor nanocrystals such as ZnSe, photoexcitation of the semiconductor resulted in efficient Mn²⁺ sensitized luminescence (FIG. 12A). However, when Mn²⁺ ions were doped into semiconductor nanocrystals with energy gaps above but close in energy to the lowest Mn²⁺ d-d excited state (⁴T₁), for example Zn₁₋ₓMnₓSe/ZnCdSe core/shell nanocrystals, thermal equilibration of excited-state populations between the ⁴T₁ and excitonic states gave rise to two luminescence bands whose ratio was extremely sensitive to temperature (FIG. 12B). The active dual-emission temperature windows could be tuned by adjusting the exciton-Mn²⁺ (⁴T₁) energy gap during nanocrystal synthesis. Although a powerful proof of concept that allowed fundamental aspects of this dual-emission mechanism to be described in detail, the Zn₁₋ₓMnₓSe/ZnCdSe nanocrystals examined previously posed some practical limitations. A strong dependence of the nanocrystal energy gap on small numbers of surface Cd²⁺ ions made these structures susceptible to photo- or thermal degradation over long experiment times, because loss of even a few Cd²⁺ ions changed the energy gap governing the thermal equilibrium. Such instabilities were exacerbated in aqueous media. The suitability of these nanocrystals for bio-related applications was also arguably compromised by the exposure of Cd²⁺ at their surfaces. In this Example, we report successful preparation of robust dual-emitting nanocrystals that are stable at high temperatures and in water, making them suitable for a broad range of applications including bioimaging.

FIG. 12C summarizes the approach used in the present example to obtain stable, dual-emitting QDs. First, Zn₁₋ₓMnₓSe cores (i) were prepared by previously reported methods. These core nanocrystals were then coated with shells of ZnS (ii), CdS (iii), and ZnS again (iv), by adaptation of methods described previously. Placement of Mn²⁺ in the QD cores ensures rapid exciton-Mn²⁺ energy transfer, and the initial ZnS shell layer significantly improves core PL quantum yields (typically from <˜10% to ˜40%), likely by passivation of surface trap states. For example, the trap-based PL near 700 nm is diminished upon ZnS shell growth. Growth of a CdS layer around the Zn₁₋ₓMnₓSe/ZnS nanocrystals lowers the nanocrystal energy gap and results in appearance of excitonic PL to the blue of the Mn²⁺ PL (FIG. 12C.iii). Beyond enhancing PL, the first ZnS shell serves as a buffer layer between the ZnSe core and the CdS layer, reducing the sensitivity of the bandgap energy to the addition of Cd²⁺ seen in our previous study by preventing formation of Cd—Se bonds. The ZnS buffer layer also reduces Mn²⁺ migration out of the ZnSe core, a problem encountered upon Cd²⁺ addition to Zn₁₋ₓMnₓSe nanocrystals under some conditions. The final ZnS layer confines the exciton away from the surface, making the QDs more photostable. Outer ZnS shells generally make QDs less prone to oxidation in aqueous solutions as well. Overall, this multi-shell synthetic method allows more precise tuning of the bandgap, and hence of the dual emission, than was achieved previously. The product nanocrystals are brighter and more stable against degradation.

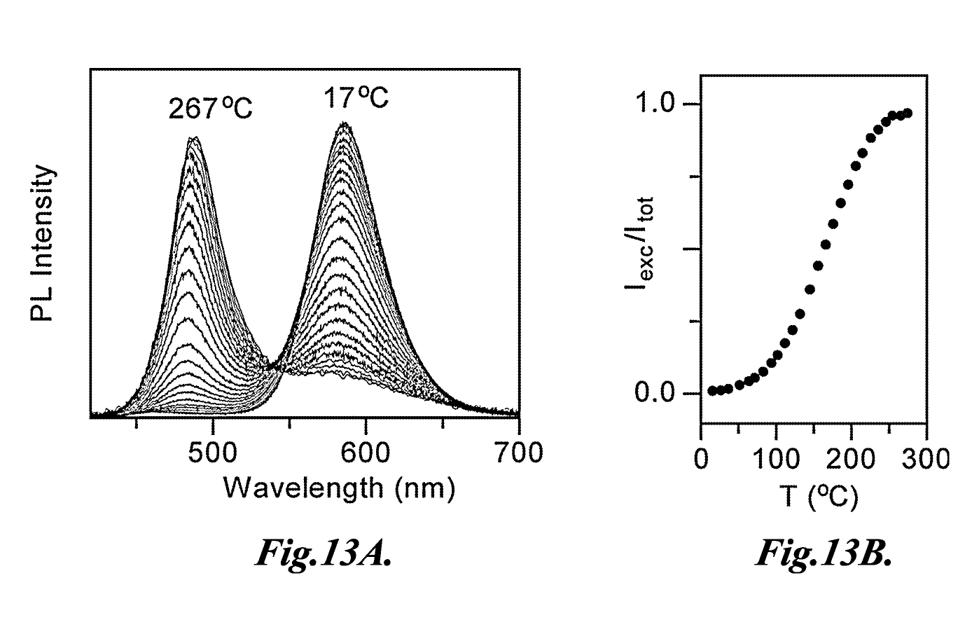

FIGS. 13A and 13B illustrate the robustness of the resulting dual-emitting nanocrystals. These nanocrystals exhibit exclusively Mn²⁺ emission (590 nm) at room temperature, with a PL quantum yield of 39%. Upon heating, excitonic PL is observed at 510 nm, concomitant with a decrease of Mn²⁺ PL. At temperatures greater than ˜250° C., the PL intensity has been shifted almost entirely from Mn²⁺ to the excitonic feature (FIG. 13A). FIG. 13B shows the thermometric response curve measured for these nanocrystals, plotting the ratio of the integrated excitonic emission (I_{exc}) to the total integrated emission (Iₜₒₜ) vs temperature. These data show a high thermometric sensitivity of ˜7×10⁻³ ° C⁻¹ over a broad window of ˜100° C. Their stability over extended measurement times at these high temperatures illustrates the thermal robustness of these core/multi-shell dual-emitters.

For these nanocrystals to be useful in bioimaging, they must retain their dual emission in water. With robust dual-emitting nanocrystals in hand, expansion of this sensing scheme to aqueous environments was therefore pursued. It is well established that the photophysical properties of nanocrystals are highly dependent on their surfaces and the surrounding medium. The Zn₁₋ₓMnₓSe/ZnCdSe dual emitters disclosed in Example 1 were unstable in water, likely due to Cd²⁺ loss from their surfaces. In contrast, the new multi-shell nanocrystals were found to be well suited for phase transfer.

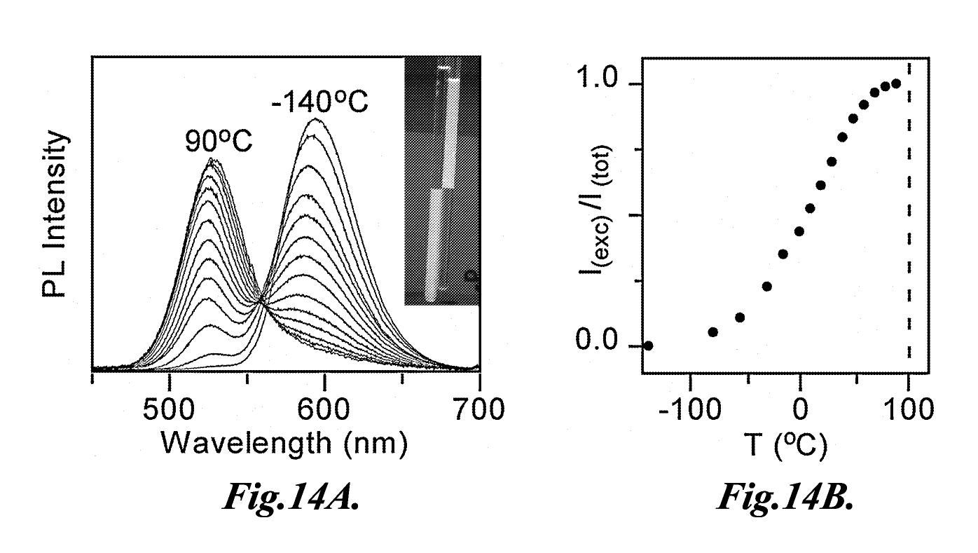

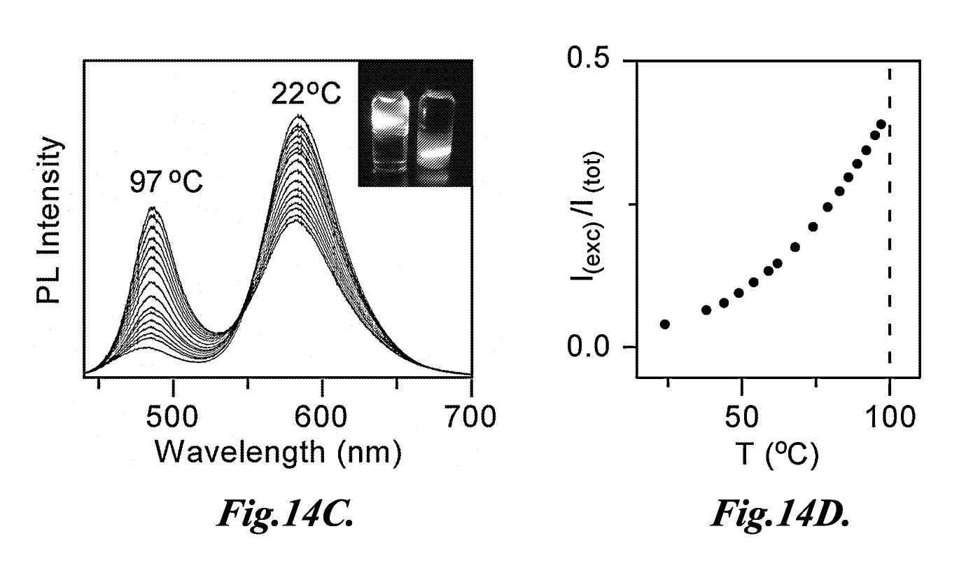

FIGS. 14A-14D demonstrate successful phase transfer of dual-emitting nanocrystals using two different methods. Exchange of the TOPO ligands with citrate yielded nanocrystals exhibiting dual emission over the full temperature range of liquid water, from near its boiling point to well below its freezing point (FIG. 14A). The photograph in the inset of FIG. 14A shows these nanocrystals in toluene and in water. Their PL QY was 10% in water (decreased from 15%) and they showed no degradation over a period of days. FIG. 14B plots the thermometric response curve measured for these nanocrystals in water, yielding a maximum sensitivity of 7.2×10⁻³ ° C⁻¹. Noteworthy is the continuity in this curve across the liquid-solid phase transition of water, despite severe reduction in optical quality of the aqueous matrix. This result illustrates the powerful advantage of ratiometric optical thermometry.

The best water solubilization was achieved using an encapsulating polymer that has the advantage of maintaining the native nanocrystal surface ligands even after phase transfer. QDs prepared in this manner are stable for months or longer at room temperature. FIG. 14C shows the temperature-dependent PL spectra of dual-emitting nanocrystals stabilized in water using n-octylamine-modified poly(acrylic) acid. Predominantly Mn²⁺ emission is observed at room temperature, and excitonic emission increases upon sample heating. FIG. 14D shows the thermometric response curve measured for these nanocrystals, which display a maximum sensitivity of 8.3×10⁻³ ° C⁻¹.

In addition to sensitivity, important metrics for evaluation of ratiometric optical thermometers are the accuracy and precision with which they can report temperature. The accuracy of these probes is determined extrinsically when constructing the calibration curves. Reproducibility of these curves is excellent due to the stability of the nanocrystals, but their accuracy is only as good as the thermometers used during data collection. With a perfect calibration curve, the precision of the optical thermometers would be determined entirely by the signal-to-noise ratios of the PL spectra. For illustration, the ratio I_{exc}/Iₜₒₜ can be determined from the data in FIGS. 14C and 14D with an error of ±1.2×10⁻³, which translates to a precision of ±0.14° C. over the entire data set. We note that this level of precision exceeds that of the thermometer used in collecting the data for the calibration curve (±0.5° C.). Each spectrum here was collected with 300 ms integration using a hand-held fiber spectrometer and no collection optics. Even higher precision can thus be obtained simply by extending integration times or improving the detection set-up.

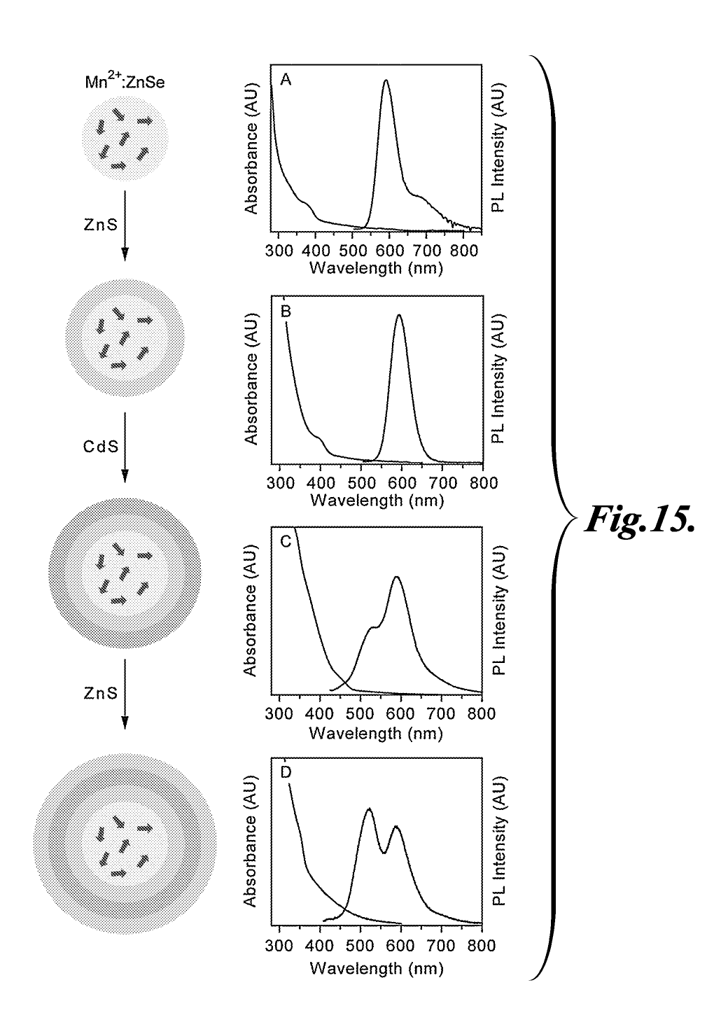

FIG. 15 illustrates on the left: Cartoon depiction of the growth of dual-emitting nanocrystals. Right: Corresponding absorption and emission spectra of these nanocrystals. (A) Core Zn₁₋ₓMnₓSe nanocrystals show a small first absorption feature near 390 nm and photoluminescence (PL) centered near 590 nm with a broad trap PL at lower energy (B) Addition of a ZnS shell to the core nanocrystals yields a small red-shift in the first absorption feature of the nanocrystals as well as a decrease in the trap PL (C) Growth of a CdS layer on the nanocrystals leads to a decrease in the energy gap resulting in a large (˜50 nm) shift of the first absorption peak and appearance of excitonic PL (D) The final ZnS layer results in some additional broadening of the absorption of the nanocrystals and a small decrease in the energy gap.

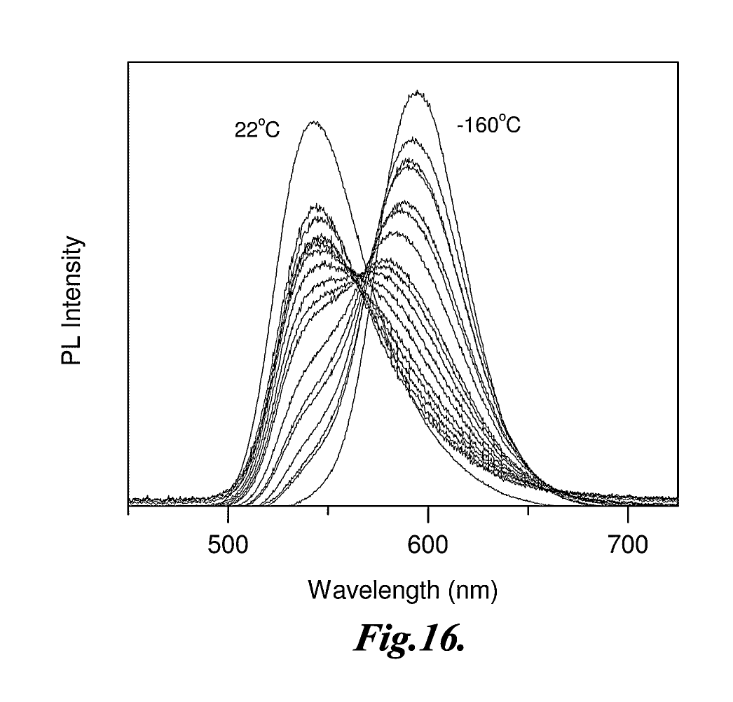

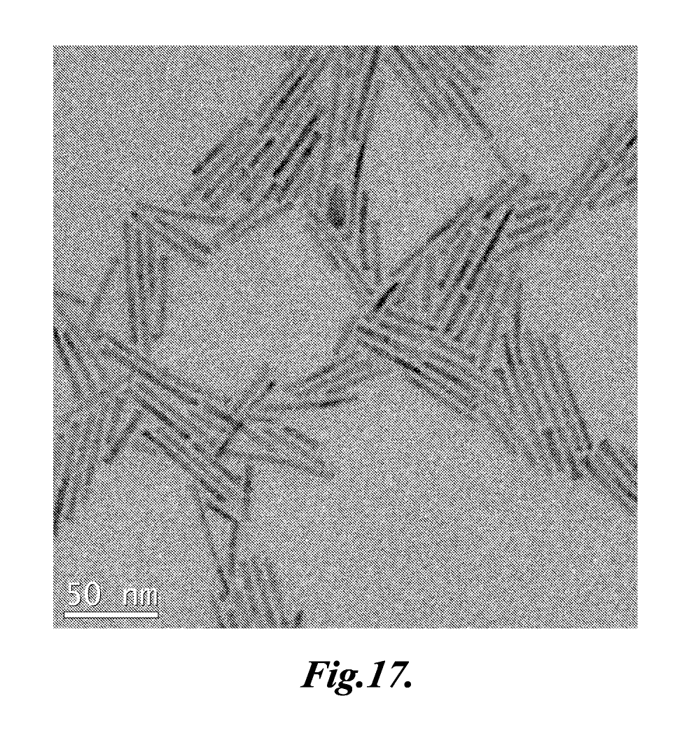

FIG. 16 illustrates variable-temperature photoluminescence (PL) spectra of colloidal Zn₁₋ₓMnₓSe/ZnS/CdS/ZnS nanorods normalized by the total integrated PL intensity. The temperature was varied from −160° C. to 22° C. for this data set. As observed with the colloidal spherical samples, the excitonic PL peak centered near 540 nm increases as the temperature is increased while the Mn²⁺⁴T₁ PL peak centered near 590 nm decreases.

FIG. 17 illustrates transmission electron microscopy image of colloidal Zn₁₋ₓMnₓSe/ZnS/CdS/ZnS rods for which the temperature dependent photoluminescence spectra are presented in FIG. 16. The rods have diameters of about 5 nm with lengths of about 50 nm.

In summary, dual-emitting Mn²⁺-doped semiconductor nanocrystals have been prepared that are stable at high temperatures and in water. Both of these advances expand the range of thermometric applications available for these sensors. In particular, with stability of these dual emitters now demonstrated in aqueous environments, the door is opened for biological or biotechnological applications, for example thermographic imaging of microfluidic PCR devices or thermometric analysis of fundamental biological processes such as cell death or protein denaturation.

Methods

Synthesis. The inorganic cluster used in the synthesis of Zn₁₋ₓMnₓSe nanocrystals, (Me₄N)₂[Zn₄(SePh)₁₀], was prepared as described in Example 1 and illustrated in FIG. 15. Zn₁₋ₓMnₓSe nanocrystals were synthesized from this cluster as follows: In a three-neck flask, hexadecylamine (HDA, 10.8 g) and MnCl₂.4H₂O (0.01 g) were heated at 130° C. under vacuum for 90 minutes. The temperature was dropped to 80° C. and the solution placed under nitrogen. Under nitrogen over-pressure, the cluster (0.2 g) and elemental selenium (Se, 0.02 g) were added to the reaction. The flask was quickly evacuated and refilled with nitrogen three times, and the reaction temperature was allowed to recover to 130° C. After stirring for 90 minutes, the temperature was ramped to 280° C. Nanocrystal growth was complete within 60 to 120 minutes, depending on the desired core size. Unreacted precursors were removed by repeated precipitation of the product nanocrystals with methanol and resuspension in toluene. These conditions were chosen to yield x ˜0.01, based on previous experience.

Shell growth precursors were prepared by adapting previously described methods. For addition of zinc sulfide to the nanocrystal surfaces, core particles, suspended in a small amount of toluene (0.01 mmol in Zn, as determined by absorption) were added to a three-neck flask containing octadecene (ODE, 4 g) and oleylamine (OLA, 0.5 g). The reaction flask was kept under vacuum at 100° C. for 30 minutes. Under a nitrogen atmosphere, the reaction was heated to 230° C., at which point an ODE solution containing zinc oleate (0.2 M) was added to the nanocrystal suspension over a period of 3-4 minutes, by syringe. The zinc precursor was allowed to react for 15 minutes prior to the addition of the sulfur precursor. Trioctylphosphine sulfide (TOPS), formed by combining elemental sulfur (1 mmol) and trioctylphosphine (5 ml, 97%, Strem), was added to the core solution over a period of 5 minutes, using a syringe pump. The precursors were allowed to react for 25 minutes prior to the addition of more zinc precursor.

The addition of cadmium sulfide to the nanocrystals was performed in an analogous fashion, with a cadmium oleate solution (20 mM in ODE) substituting for the zinc oleate solution. Cationic and anionic precursors were added until the desired energy gap was achieved.

The final ZnS shell was added to the nanocrystals in the same fashion as the first ZnS layer. Following synthesis, these nanocrystals were washed by repeated precipitation with ethanol and resuspension in toluene.

Water-soluble nanocrystals were first obtained by cap-exchange of the native TOPO ligands with citrate. Nanocrystals were isolated by precipitation from toluene with ethanol. Sodium citrate was added to the pellet and the solids were dispersed in ethanol by sonication over the course of 1 hour. The dots were then isolated from ethanol through centrifugation and the process was repeated 4-5 times with fresh ethanol and sodium citrate added with each repetition. The pellet was then washed with toluene 3 times and then with ethanol once more to remove residual toluene. The particles were suspended in aqueous solution by sonication in water with additional sodium citrate.

Nanocrystals encapsulated by n-octylamine-modified poly(acrylic) acid (PAA) were prepared by previously reported methods. PAA was functionalized with 40% n-octylamine groups by amide bond formation with 1-ethyl-3-(3-dimethylaminopropyl) carbodiimide and N-hydroxysuccinimide. Nanocrystals were isolated by repeated precipitation from toluene with ethanol and re-dissolved in a minimal amount of chloroform (CHCl₃). A solution of the modified polymer in CHCl₃ was added to the nanocrystal solution and left stirring overnight. After removing the CHCl₃ by vacuum, sodium bicarbonate buffer (pH ˜8.5) was added to suspend the nanocrystals. The solution was then dialyzed at least three times (with 50 kDa MW cutoff spin concentrators, Millipore) to furnish aqueous nanocrystals.

Characterization. Absorption spectra of the colloidal nanocrystals were collected using a Cary 500 (Varian) spectrophotometer. Room- and low-temperature continuous-wave PL measurements were performed on colloidal suspensions of nanocrystals in toluene. High-temperature spectra were taken in ODE under nitrogen atmosphere. Low-temperature spectra were obtained with frozen suspensions of colloidal nanocrystals cooled by liquid nitrogen. An unfocused 405 nm laser (˜30 mW) was used as the excitation source, and a USB2000 Miniature Fiber Optic Spectrometer (Ocean Optics) was used for detection. PL quantum yields were measured using an Absolute Photoluminescence Quantum Yield Measurement System C9920-02 (Hamamatsu). TEM images were obtained using an FEI TECNAI F20, 200 kV transmission electron microscope.

### Example 3

### Dual Emission Alloy Semiconductor Nanocrystals

In the present example, alloyed nanocrystals composed of Zn_{1-x-y}CdₓMn_{y}Se have been synthesized that display dual emission. The simplified synthesis of these materials is exemplified in that dual emission is observed following a one-step reaction.

The same photophysical process presenting in Examples 1 and 2 describes the current example. The energetic proximity of the Mn²⁺⁴T₁ excited state to the conduction band of the Zn_{1-x-y}CdₓMn_{y}Se alloy material allows thermal population of both states resulting in photoluminescence from both the exciton and Mn²⁺. Although the samples presented in Example 2 (Zn₁₋ₓMnₓSe/ZnS/CdS/ZnS) were stable at high temperatures and in aqueous solution, the synthesis required multiple time-consuming steps to complete due to the multi-shell structure. Combination of Zn²⁺, Mn²⁺, Cd²⁺, and Se precursors in the appropriate ratios followed by heating yields Zn_{1-x-y}CdₓMn_{y}Se nanocrystals exhibiting intrinsic dual emission in a single step. Following isolation of the nanocrystals, their quantum yields may be enhanced by thermal annealing and/or addition of a ZnS shell. The resulting nanocrystals have quantum yields of up to ˜20% and are comparably stable to their core-multishell analogs.

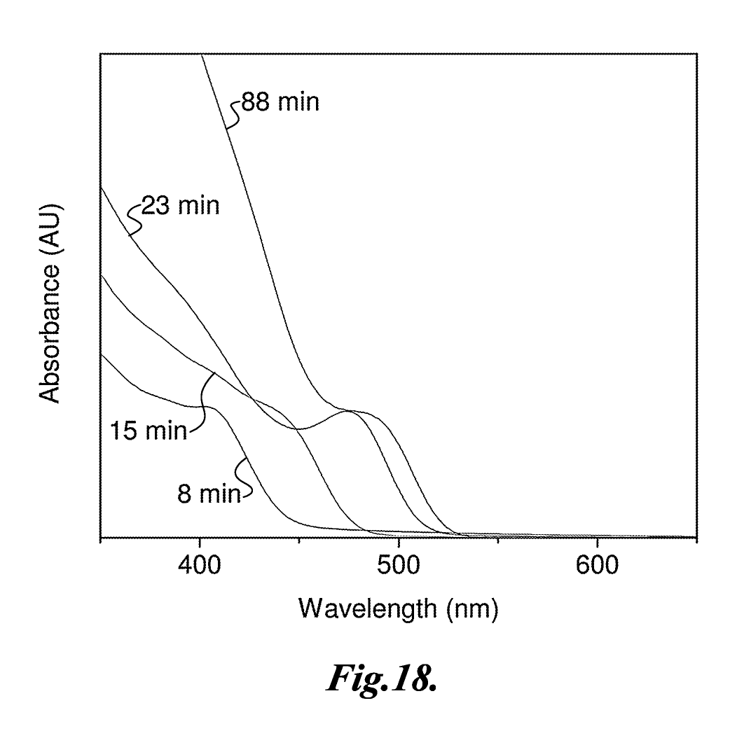

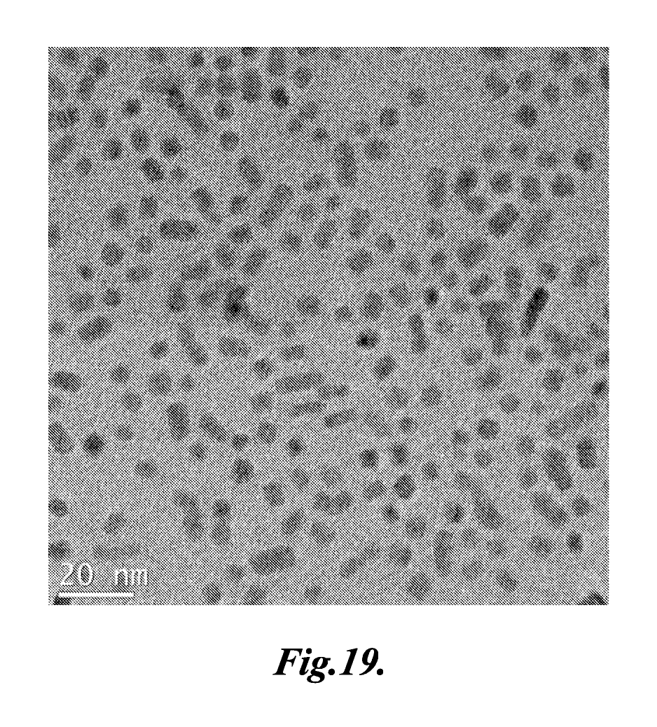

FIG. 18 illustrates absorption spectra of Zn_{1-x-y}CdₓMn_{y}Se nanocrystals during reaction progress. The energy of the first absorption feature of the nanocrystals red shifts over time. Aliquots were taken from the reaction medium at 8 minutes, 15 minutes, 23 minutes, and finally at 88 minutes.

FIG. 19 illustrates transmission electron microscopy image of Zn_{0.874}Cd_{0.105}Mn_{0.021}Se nanocrystals. Short rods and dots are observed.

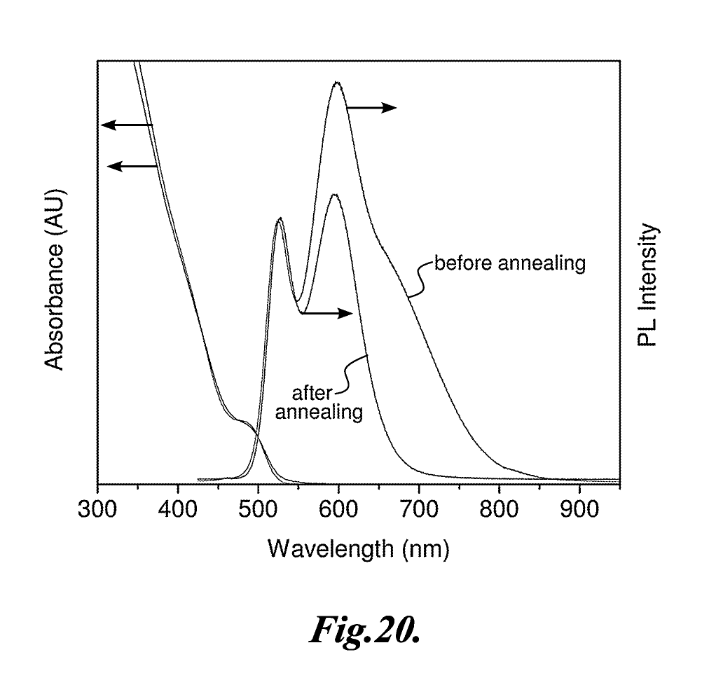

FIG. 20 illustrates absorption and photoluminescence (PL) spectra of Zn_{1-x-y}CdₓMn_{y}Se nanocrystals before and after annealing. The absorption spectra are normalized to the first absorption feature. The PL spectra are normalized to the excitonic emission peak centered near 525 nm. The trap emission centered near 700 nm decreases during annealing while the excitonic emission intensity increases.

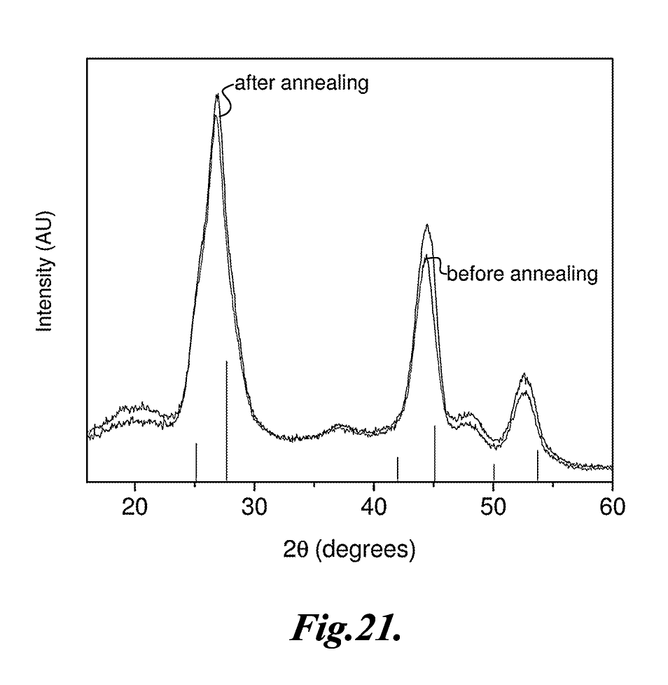

FIG. 21 illustrates x-ray diffraction spectra of Zn_{1-x-y}CdₓMn_{y}Se nanocrystals before and after annealing. There is little change observed before and after the annealing process. The spectra indicate the nanocrystals possess zinc blende structure and the peak positions fall close to those of pure ZnSe but shifted slightly towards those of pure CdSe.

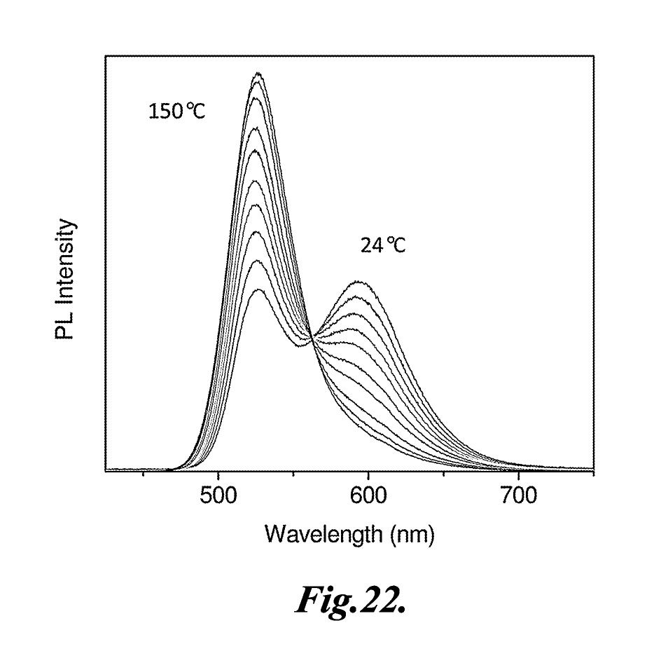

FIG. 22 illustrates variable-temperature photoluminescence (PL) spectra of colloidal Zn_{0.874}Cd_{0.105}Mn_{0.021}Se nanocrystals normalized by the total integrated PL intensity. The temperature was varied between 24° C. and 150° C. for this data set. The excitonic PL peak centered near 525 nm and the Mn²⁺⁴T₁ PL peak centered near 595 nm exhibit near equal emission intensities at 24° C. The excitonic PL peak increases as the temperature is raised while the Mn²⁺⁴T₁ PL peak decreases.

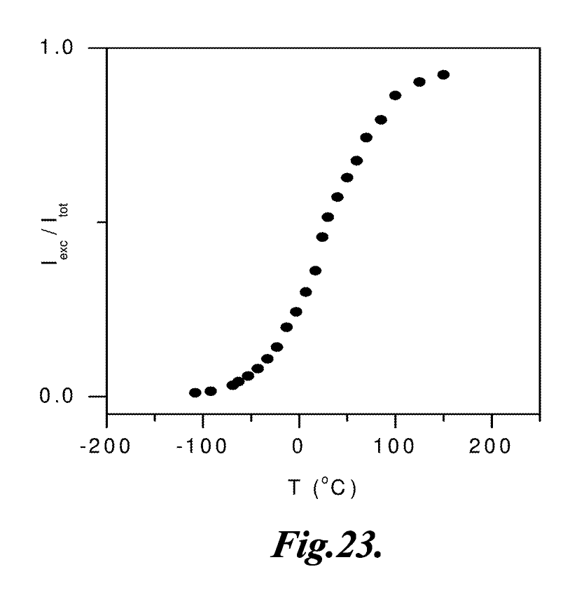

FIG. 23 illustrates thermometric response curve plotting I_{exc}/Iₜₒₜ vs temperature for the nanocrystals shown in FIG. 22. A maximum slope of 6.7×10⁻³ ° C⁻¹ was obtained.

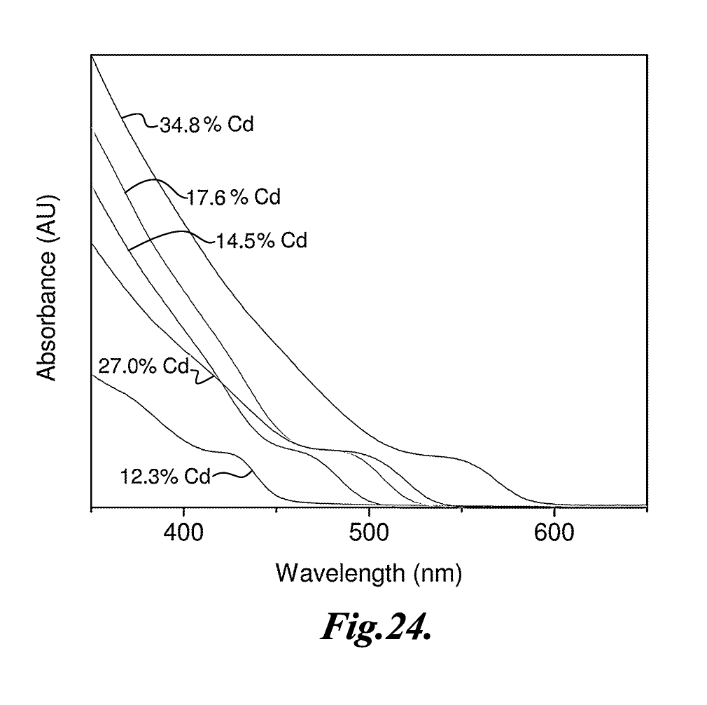

FIG. 24 illustrates absorption spectra of Zn_{1-x-y}CdₓMn_{y}Se nanocrystals with varying composition. The amount of cadmium within the particles as determined by inductively coupled plasma atomic emission spectroscopy is indicated. Generally, higher percentages of cadmium correspond to smaller band gap energies. Longer growth times resulting in larger nanocrystals can also lead to smaller band gap energies. The manganese composition ranged from 0.9% to 2.9% for these samples.

Methods

Synthesis. The inorganic cluster used in the synthesis of Zn₁₋ₓMnₓSe nanocrystals, (Me₄N)₂[Zn₄(SePh)₁₀], was prepared as described previously. Zn_{1-x-y}CdₓMn_{y}Se nanocrystals were synthesized from this cluster as follows: in a three-neck flask, hexadecylamine (HDA, 10.8 g), MnCl₂.4H₂O (0.027 g), and the desired amount of CdCl₂.2.5H₂O (0.015 g for dual emission at room temperature) were heated at 100° C. under vacuum for 90 minutes. The solution was placed under nitrogen and the temperature was dropped below 80° C. Under nitrogen over-pressure, the cluster (0.2 g) and elemental selenium (Se, 0.01 g) were added to the reaction. The flask was quickly evacuated and heated at 100° C. for 60 minutes. The reaction was places under nitrogen and the temperature was ramped to 280° C. Nanocrystal growth was complete within 60 to 120 minutes, depending on the desired core size. Unreacted precursors were removed by repeated precipitation of the product nanocrystals with ethanol and resuspension in toluene. These conditions were chosen to yield x ˜0.02, based on previous experience.

Nanocrystals were annealed in a degassed solution of octadecene (ODE, 1.5 g) and oleylamine (OLA, 1.5 g) at 280° C. under nitrogen until the desired brightness was achieved. After cooling the reaction to room temperature, the nanocrystals were isolated by precipitation with ethanol followed by resuspension in toluene.

Shell growth precursors were prepared by adapting previously described methods. For addition of zinc sulfide to the nanocrystal surfaces, core particles, suspended in a small amount of toluene (0.01 mmol in Zn, as determined by absorption) were added to a three-neck flask containing octadecene (ODE, 1.5 g) and oleylamine (OLA, 1.5 g). The reaction flask was kept under vacuum at 100° C. for 30 minutes. Under a nitrogen atmosphere, the reaction was heated to 220° C., at which point an ODE solution containing zinc oleate (0.2 M) was added to the nanocrystal suspension over a period of 3-4 minutes, by syringe. The zinc precursor was allowed to react for 15 minutes prior to the addition of the sulfur precursor. Trioctylphosphine sulfide (TOPS), formed by combining elemental sulfur (1 mmol) and trioctylphosphine (5 ml, 97%, Strem), was added to the core solution over a period of 5 minutes, using a syringe pump. The precursors were allowed to react for 25 minutes prior to the addition of more zinc precursor. Following synthesis, these nanocrystals were washed by repeated precipitation with ethanol and resuspension in toluene.

Characterization. Absorption spectra of the colloidal nanocrystals were collected using a Cary 500 (Varian) spectrophotometer. Room- and low-temperature continuous-wave PL measurements were performed on colloidal suspensions of nanocrystals in toluene. PL quantum yields were measured using an Absolute Photoluminescence Quantum Yield Measurement System C9920-02 (Hamamatsu). TEM images were obtained using an FEI TECNAI F20, 200 kV transmission electron microscope. Cation concentrations were determined using inductively coupled plasma atomic emission spectroscopy (ICP-AES, Perkin Elmer Optima 8000) after acid digestion of samples.

While illustrative embodiments have been illustrated and described, it will be appreciated that various changes can be made therein without departing from the spirit and scope of the invention.

The embodiments of the invention in which an exclusive property or privilege is claimed are defined as follows:

1. A composition, comprising:
(a) a host material having a host luminescent state; and
(b) a luminescent dopant having a dopant luminescent state that is lower in energy than the host luminescent state;
wherein the luminescent dopant is in electronic communication with the host;
wherein the luminescent states of the host and the luminescent dopant are separated by an energy gap;
wherein the energy gap is sufficiently small that thermal energy is sufficient to bridge the energy gap;
wherein a luminescence lifetime of the dopant luminescent state is at least 10 times longer than a luminescence lifetime of the host luminescent state;
wherein the composition exhibits simultaneous luminescent emission at two distinct peak wavelengths, a first emission peak wavelength defined by the host luminescent state and a second emission peak wavelength defined by the dopant luminescent state; and
wherein the intensity of the first emission peak wavelength and the intensity of the second emission peak wavelength vary inversely in response to variations in thermal energy.

2. The composition of claim 1, wherein the host material is a wide-gap semiconductor.

3. The composition of claim 1, wherein the host material is a compound semiconductor.

4. The composition of claim 3, wherein the host material comprises a plurality of semiconductor components selected from the group consisting of zinc, cadmium, selenium, sulfur, tellurium, oxygen, gallium, arsenic, indium, phosphorous, nitrogen, tin, germanium, silicon, and carbon.

5. The composition of claim 3, wherein the compound semiconductor is an alloy.

6. The composition of claim 3, wherein the compound semiconductor has a core and a shell, each of which has a different composition.

7. The composition of claim 6, wherein the compound semiconductor shell comprises a plurality of shells.

8. The composition of claim 6, wherein the luminescent dopant is entirely contained within the core.

9. The composition of claim 1, wherein the luminescent dopant is a transition metal.

10. The composition of claim 1, wherein the luminescent dopant is a lanthanide.

11. The composition of claim 1, wherein the host material is a nanoparticle, having at least one dimension measuring 100 nm or less.

12. The composition of claim 1, wherein the host material has a shape selected from the group consisting of an irregular or regular particle, a sphere, a rod, a faceted polyhedron, a cube, a tetrapod, a branched structure, a dumbbell, and a bullet.

13. The composition of claim 1, wherein the host material is amorphous.

14. The composition of claim 1, wherein the host material is a powder.

15. The composition of claim 1, wherein the host material is a film.

16. The composition of claim 1, wherein the energy gap is from about 0.5 electron volts to about 0.0013 electron volts.

17. The composition of claim 1, wherein the thermal energy is provided by an ambient temperature of from about 0 kelvin to about 700 kelvin.

18. The composition of claim 1, wherein the wherein the luminescence lifetime of the dopant luminescent state is at least 1000 times longer than the luminescence lifetime of the semiconductor luminescent state.

19. The composition of claim 1, wherein the composition has a luminescent quantum yield of at least 10%.

20. The composition of claim 1, wherein the composition comprises an alloy of zinc, cadmium, manganese, and selenium.

21. The composition of claim 20, wherein the composition is Zn_{1-x-y}Cdₓ Mn_{y} Se, wherein x is from about 0.01 to about 0.5 and y is from about 0 to about 0.2.
